(19) United States
(12) Patent Application Publication
(10) Pub. No.: US 2022/0196981 A1
(43) Pub. Date: Jun. 23, 2022

(54) Lens Systems Using Free Form Elements to Match Object Space and Image Space, and Methods Therefor

(71) Applicants: Vadim VLAKHKO, Moscow (RU); Jyh Long CHERN, Chubei City Hsinchu (TW); Fedor CHURLIAEV, Moscow (RU); DynaOptics, Ltd, Menlo Park, CA (US)

(72) Inventors: Vadim Vlakhko, Moscow (RU); Jyh Long Chern, Chubei City (TW); Fedor Churliaev, Moscow (RU); Li Han Chan, Oakland, CA (US)

(21) Appl. No.: 17/236,871

(22) PCT Filed: Oct. 22, 2019
(86) PCT No.: PCT/US19/57467

§ 371 Date: Apr. 21, 2021

Related U.S. Application Data
(63) Continuation-in-part of application No. 15/958,804, filed on Apr. 20, 2018.
Application No. 15/958,804 is a continuation-in-part of application No. PCT/IB2016/001630, filed on Oct. 20, 2016.
(60) Provisional application No. 62/748,961, filed on Oct. 22, 2018.
(60) Provisional application No. 62/748,976, filed on Oct. 22, 2018.
(60) Provisional application No. 62/244,171, filed on Oct. 20, 2015.

(51) Int. Cl. G02B 13/00; H04M 1/02

(52) U.S. Cl. CPC G02B 13/0045; G03B 30/00; H04M 1/026

(57) ABSTRACT

Lens system suited for a wide variety of applications uses a variety of freeform lens shapes or surfaces, defined typically by Zernike, Chebyshev or X-Y polynomials to enable low f-number, wide field of view, improved off-axis performance, and other optical characteristics not achievable with rotationally symmetric lenses. The design can be implemented using existing manufacturing techniques.

### RELATED APPLICATIONS

This application is a conversion of U.S. Patent Application Ser. No. 62/748,961, filed Oct. 22, 2018, having the same title as the present application, and further is a conversion of U.S. Patent Application Ser. No. 62/748,976, also filed Oct. 22, 2018, entitled Low F-Number Optical System Utilizing Double Plane Symmetry Defined by X-Y Polynomial. Further, this application is a continuation-in-part of U.S. patent application Ser. No. 15/958,804 filed on Apr. 20, 2018, entitled Low Distortion Lens Using Double Plane Symmetric Element, which in turn is a continuation-in-part of PCT Application PCT/IB2016/001630 having International Filing Date 20 Oct. 2016, which in turn claims the benefit of U.S. Patent Application 62/244,171, filed 20 Oct. 2015. The present application claims the benefit of priority of each of the foregoing applications, all of which are incorporated herein for all purposes.

### FIELD OF THE INVENTION

This invention relates generally to lens systems using free form lenses, and more particularly relates to lens systems configured to provide matching of the object space to the image space according to the application for which the lens system is used. An aspect of this invention relates generally to lens systems using double plane symmetry freeform lenses, and more particularly relates to lens systems using double plane symmetry lens elements for time of flight and machine vision applications where the surface or Z-sag of the double plane symmetry surface is defined by an X-Y polynomial

### BACKGROUND OF THE INVENTION

The general task of an optical design is to make a perfect conjugation between the object space or plane and the image space or sensor plane, with no aberrations, distortions or other errors. Although many lenses are very good, such perfection is elusive. Even small increments can provide significant benefit.

Rotational symmetry is widely used in conventional lenses, with the field of view and the aperture stop both being rotationally symmetric. With only rare exception, this results in the final design comprising rotationally symmetric elements. An example of such a conventional design is shown in FIG. 1.

However, most sensors—the photosensitive structures that record the image—are rectangular in shape. Thus, as shown in FIG. 2, the image space created by the lens of FIG. 1 creates a circular field of view, while the sensor that records the image is a rectangle. In an effort to optimize the mismatch, the diameter of the field of view of the lens system is matched to the diagonal size of the sensor.

Lens designs using only rotationally symmetric lenses attempt to achieve as good as possible image quality (IQ) inside the circular image space field of view. The objective includes minimizing optical aberrations such as spherical errors, coma, astigmatism, field curvature, distortion, axial and lateral aberration, color, and others. An inherent characteristic of rotationally symmetric designs is that the optical errors in the lenses are the same at all points equidistant from the center of the lens, even though points outside the area of the sensor are of no consequence to the stored image. Thus, optimal lens performance cannot be matched to the sensor's field of view, and the result is similar to that shown in FIG. 3.

Conventional optical systems introduce perspective aberrations for wide angle, low distortion lenses. The larger the field of view and the lower the distortion, the more pronounced such perspective aberrations become. As an example, it is common for objects at the edge of a wide angle image to appear stretched. This can be seen whether the undistorted wide angle image is the result of the optics, or is digitally dewarped from a distorted image. This perspective aberration is less apparent in images that have significant distortion, and becomes more apparent as distortion is reduced.

For lenses capturing fields of view larger than 180 degrees, the image which actually reaches the typical rectangular sensor is a circle that does not fill up the whole rectangular sensor. This results in a lower resolution image than the sensor is capable of detecting. However, traditional rotationally symmetrical lenses typically are unable to create a non-circular image plane without introducing unacceptable image degradation due to aberrations.

Depending upon the application of the lens system, numerous other considerations must be taken into account, including total track length of the lens system, f-number, aspect ratio, color rendering index (CRI), chief ray angle (CRA), chief ray height (CRH), uniformity over relative illumination, and so on. Frequently, trade-offs must be made among these various considerations to provide a lens system well suited to a particular application. Rotationally symmetric lenses frequently do not offer the desired flexibility

As a result, there is a need for lens system designs that take into account the particular application when matching the object space to the image space, for example the field of view of a sensor.

### SUMMARY OF THE INVENTION

The present invention provides a plurality of optical designs using free form lenses which overcome the limitations of conventional rotationally symmetric designs while also taking into consideration the particular application and the considerations associated with that application. At a fundamental level, the optical designs of the present invention permit—depending upon the application—different optical power, field of view, aberration correction, and so on to be made along the X axis than along the Y axis. To achieve this improvement, one or more optical elements having double plane symmetry or other free form characteristics is introduced into the optical system.

Depending upon the embodiment, a freeform optical element as contemplated by the present invention can have one optical surface with double plane symmetry, while the other surface is rotationally symmetrical. Alternatively, both surfaces can have double plane symmetry, or one surface may have another form of asymmetry, such as a surface defined by a Zernike or Chebyshev polynomial, or a hybrid Zernike lens element, or a lens element with a diffractive surface. Multiple such freeform optical elements are also possible in the optical system. In the case of multiple elements having double plane symmetry, the orientation of the freeform elements in the assembly has to be aligned.

Through the use of one or more such freeform optical elements, the image projected onto the sensor is better matched to the field of view of the sensor, resulting in enhanced resolution of the captured imaged and, effectively, higher resolution. This better matching offers significant benefits in many optical applications, including lens modules for smartphone cameras, virtual reality and augmented reality optics, time of flight systems, machine vision systems, security cameras, and so on. One example of the benefits of such better matching is in the virtual reality context, where dewarping an image taken with conventional rotational optics can take two days or more, while dewarping of that same image when captured with an appropriately designed free form lens system may take only a few hours.

In an embodiment of the invention, the lens design of the present invention is particularly well suited to wide angle lenses, but in some implementations is also advantageous for normal and telephoto or zoom lenses. In addition, the lens design can be implemented as a fixed focal length lens attachment to an existing lens, such as might be integrated into a smart phone. In other applications, for example non-imaging applications such as time-of-flight sensing, lens characteristics are optimized around narrow wavelength bands such as infrared or near infrared. More broadly, the present invention makes possible numerous machine vision solutions not available with conventional rotationally symmetric lenses. Such solutions can be implemented across a wide range of wavelengths, for example from 350 nanometers to 2500 nanometers. The materials used for the optical elements will typically be optimized for the relevant wavelength to ensure proper transmittance,

While double plane symmetric lenses and their associated lens systems offer excellent solutions for many optical applications, as noted above other free form lens designs offer options not available with either rotationally symmetric or double plane symmetric lens systems.

Perspective aberration can be corrected with these types of free form optical elements. As noted above, perspective aberration results in an elongation, or stretching, of the object on the image plane of the sensor. The larger the field of view and the lower the optical distortion, the more apparent such perspective aberration becomes. Traditional optical system typically results in a constant effective focal length of the optical system throughout the field of view. The use of such freeform lens elements in accordance with the present invention implements a varying effective focal length of the optical system with respect to the field of the view. The changing effective focal length can be implemented for lenses that are rotationally symmetric, as discussed below in connection with FIG. 22. This changing effective focal length can, alternatively, be implemented with different rates of change of focal length along the X-axis and Y-axis. In an embodiment, this minimizes perspective aberration and can be accomplished while maintaining other optical performance such as image resolution.

For rotationally symmetric optical systems having a field of view larger than 180 degrees, the image plane on the sensor is a circle that does not completely fill the sensor. The freeform optical elements of the present invention allow a different effective focal length in the X-axis than in the Y-axis. This results in an image plane that is not a circle and instead may be an oval which fills up more of the rectangle sensor. This increases the effective resolution of the image. Those skilled in the art will recognize that the design characteristics of a double-plane symmetry lens in accordance with one aspect of the present invention can be described by an XY polynomial, for example. In addition, certain forms of a Zernike polynomial can also be used to describe a double-plane symmetry lens in accordance with the present invention. Further, some forms of a Chebyshev polynomial can be used to describe a double-plane symmetry lens according to an aspect of the present invention.

Using polynomial expressions such as Zernike and Chebyshev in addition to X-Y polynomials also permits the design of more complicated lens systems utilizing the benefits of free-form lenses. Such lens designs can include, but are by no means limited to: panoramic free form lens systems with a low f-number and short total track length; super-wide angle lens systems; lens systems for mobile phone applications with very short track length and very high on-axis performance; hybrid free form lens designs having an f-number in the range of 1.6 while also capable of mating to a large sensor and a short total track length; diffractive free-form lens designs for mobile phone applications; and lens designs for non-imaging applications such as 3D cameras or time of flight systems for applications in, for example, mobile, autonomous and semi-autonomous vehicles, or other machine vision applications.

The elements of these lens systems, and the lenses themselves, can be fabricated using existing techniques and can be scaled in size. Thus, in addition to the above examples, lens system designs in accordance with the present invention are suitable for a variety of applications, including security cameras, smart phone attachments, dash cams, action cams, web cams, drone cameras, front facing “selfie” cameras, and a broad variety of machine vision systems including time of flight systems. Broadly stated, aspects of the present invention can be implemented to provide significant improvement in many imaging and non-imaging sensing applications.

Additional aspects of the invention are set forth in the attached Appendix, the disclosure of which is incorporated herein for all purposes.

These and other benefits of the design of the present invention can be appreciated from the following detailed description of the invention, taken together with the appended figures.

### THE FIGURES

FIG. 1 [Prior Art] depicts the relationship between an object plane, a lens and an image plane.

FIG. 2 [Prior Art] illustrates the relationship between the field of view of a rotationally symmetric lens and the field of view of a rectangular sensor.

FIG. 3 [Prior Art] illustrates the inability of rotationally symmetric lens designs to optimize image quality within the sensor area.

FIG. 4 illustrates the improved image quality at the sensor possible with the present invention.

FIG. 5 illustrates an embodiment of a Kepler-type afocal telescopic lens design in accordance with the present invention.

FIGS. 6A-6B illustrate in ray diagram and table form details of an embodiment of a lens design in accordance with the invention.

FIGS. 7 and 9 shows the improved optical image quality achievable with a lens design in accordance with the present invention.

FIGS. 8 and 10 [Prior art lens design] graphically illustrate optical image quality for a conventional, rotationally symmetric lens design, especially edge softness.

FIGS. 11A-11B show an embodiment of a five-element afocal Galileo-type telescopic lens design in accordance with the present invention.

FIGS. 12A-12B show a ray path diagram of the lens design of FIGS. 11A-11B.

FIGS. 13 and 14 graphically illustrate image quality for the lens design of FIG. 11A.

FIG. 15 illustrates in ray path form the performance of a low distortion wide angle lens in accordance with the present invention.

FIG. 16 shows a double symmetry lens element in accordance with the present invention.

FIGS. 17-19 graphically illustrate the performance of a wide angle lens design in accordance with the present invention.

FIG. 20 illustrates the traditional optical systems having a constant effective focal length of the whole field of view of the sensor

FIG. 21 illustrates an optical system where the effective focal length changes with the field on the sensor

FIG. 22 illustrates how the effective focal length changes over the image sensor in a rotationally symmetric manner

FIG. 23 illustrates the effective focal length changes differently along the X-axis and Y-axis on the image plane

FIG. 24 illustrates a conventional image circle for a larger than 180 deg FOV lens (left) and a non-circular image circle for increased pixels.

FIG. 25A illustrates in cross-sectional side view an embodiment of the invention, specifically a panoramic or super wide angle lens implemented by means of a lens element having a highly asymmetrical Zernike surface.

FIG. 25B illustrates an example of the highly asymmetrical surface referred to in FIG. 25A.

FIGS. 26A-26B illustrate graphically the benefits of the lens system of FIGS. 25A-25B.

FIG. 27A illustrates an embodiment of the invention suited to mobile applications, particularly those requiring a high modulation transfer function and high Strehl yet with a small track length.

FIG. 27B illustrates a free form lens element suited to the embodiment of FIG. 27A comprising an aspheric surface and a Zernike surface.

FIGS. 28A and 28B illustrate performance characteristics of the embodiment shown in FIG. 27A.

FIG. 29A illustrates an embodiment of the invention suited to a mobile implementation having a large sensor and a low f-number, and also a moderately short track length.

FIG. 29B illustrates an embodiment of a free form lens element suited to the embodiment of FIG. 29A wherein the lens element comprises a hybrid of a glass base lens having on one surface thereof a UV curable material with a surface defined by a Zernike polynomial.

FIG. 30 shows on axis wavefront error for the embodiment shown in FIG. 29A.

FIG. 31A illustrates an embodiment of the invention suited to a mobile application where a diffractive free form lens enables the use of fewer elements and therefore a particularly short track length.

FIG. 31B illustrates an example of a diffractive lens element suited for use in the embodiment of FIG. 31A.

FIGS. 32A and 32B show, respectively, on-axis wavefront error and on-axis point spread for the embodiment shown in FIG. 31A.

FIG. 33 illustrates an embodiment of the invention suited for machine vision applications where low f-number is desirable.

FIG. 34 illustrates an embodiment of the invention suited to time-of-flight systems, which can be considered a specific application of machine vision.

FIG. 35 shows an embodiment of a lens system suited to use in mobile and similar applications where the free form lens surfaces are defined using extended X-Y Polynomial.

FIG. 36 shows in table form the constituent elements of the embodiment shown in FIG. 35.

FIGS. 37A-37D show in table form exemplary coefficients for the embodiment shown in FIG. 35.

### DETAILED DESCRIPTION OF THE INVENTION

Referring first to FIG. 4, illustrated therein is a general description of the improvement in image quality that can be achieved by the use of a free form lens and permitting different optimization at different distances from the axis of the lens. The area of the sensor, indicated at 100, is shown to have best image quality, while areas outside of the sensor, indicated at 110, are permitted a reduced quality since these areas are irrelevant to the image captured by the sensor.

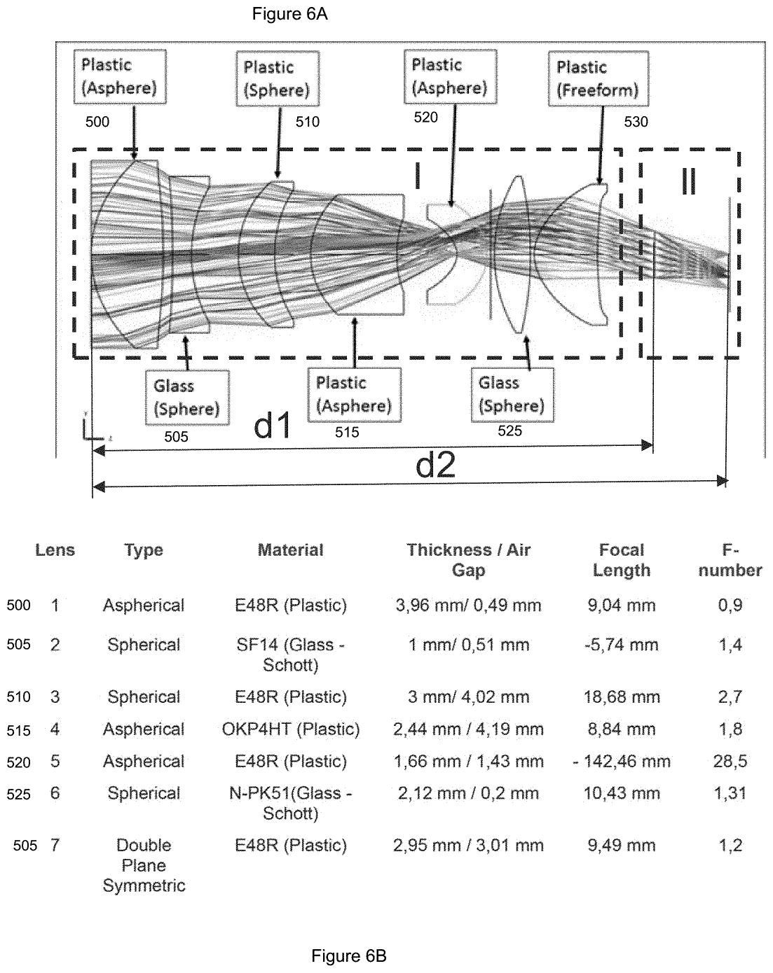

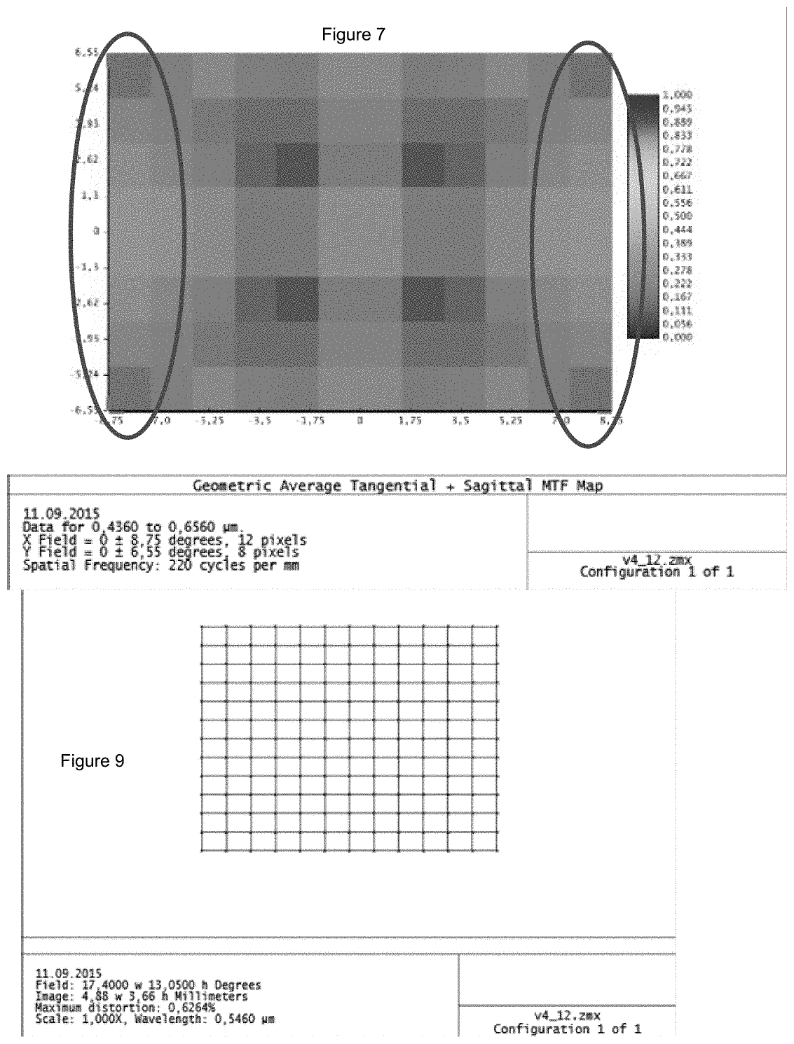

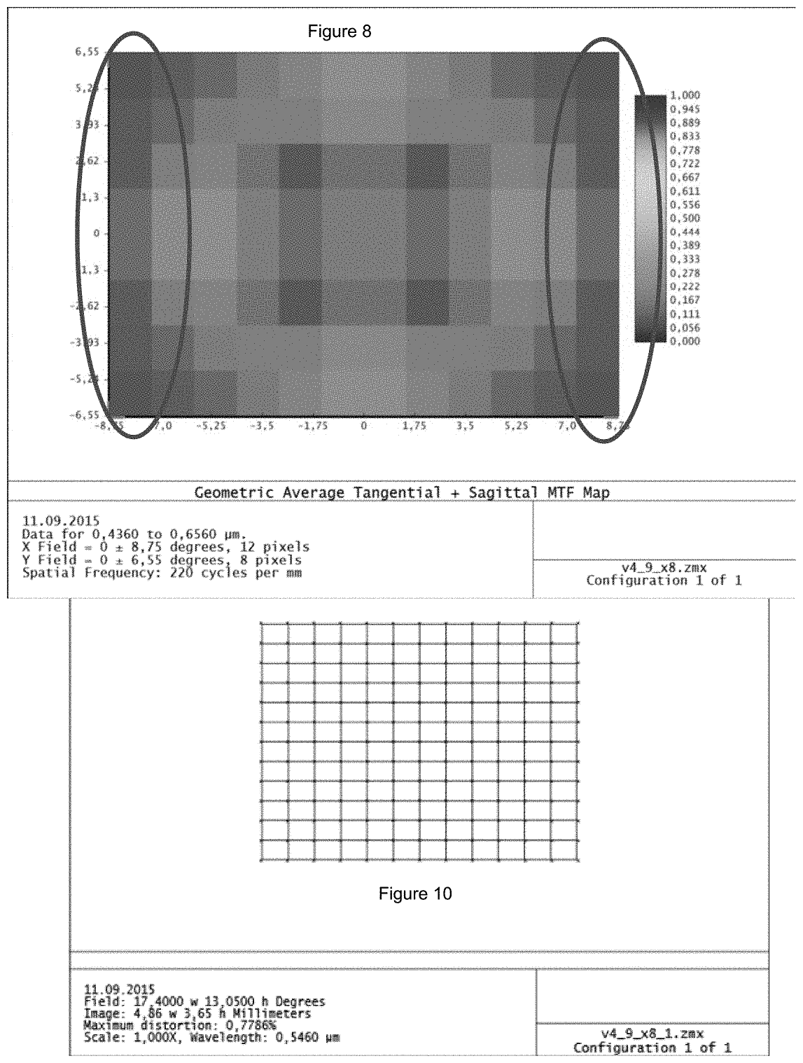

Next with reference to FIGS. 5 and 6A-6B, an embodiment of a lens system in accordance with one aspect of the invention can be better appreciated. In the illustration of FIGS. 5 and 6A, a seven element lens system is shown in perspective and ray trace form, although not necessarily shown to scale. FIG. 6B presents in table form the details of the lens elements, while FIGS. 7 and 9 illustrate image quality and distortion information of the design as compared to the image quality and distortion information of a conventional rotationally symmetric lens shown in FIGS. 8 and 10.

Thus, as can be seen from FIG. 6A and 6B, the first lens element, 500, can be seen to be aspheric and fabricated from a plastic such as E48R or equivalent. The second lens element, 505, is spherical and can fabricated from Schott SF14. The third element, 510, is also spherical but can be made from E48R plastic. Element 515 is, in the embodiment shown, aspherical and can be made from OKH4HT plastic. Element 520 is aspherical and can be made from E48R plastic, while element 525 is spherical in the embodiment shown and can be made from N-PK51 Schott glass. Finally, element 530 is double plane symmetrical in shape and can be made from E48R plastic. Those skilled in the art will recognize that the particular materials are shown for exemplary purposes only, and numerous other materials provide substantially equivalent results with appropriate adjustments for the changed materials. The design of FIGS. 5, 6A-6B can be seen to be a Kepler type afocal telescopic system, comprising two major portions. Elements 500-515 comprise the objective portion, while lenses 520-530 comprise the eyepiece portion. For the example shown, both portions have positive optical power. The resulting lens has a nominal field of view of 17.4 degrees along the X axis, and 13.1 degrees along the Y axis, with a magnification of 4X, a total track of 31 mm, a distance from the last surface to the exit pupil of 3 mm, and an objective and eyepiece f-number of 1.67.

The lens design of FIG. 5 is particularly useful as an afocal telephoto lens of a fixed focal length, suitable for attaching to the front of a smart phone. This arrangement can be better appreciated from FIG. 6A, where the lens of FIG. 5 is indicated as portion I, and a smart phone camera is indicated as portion II. For purposes of clarity, the lens of the smart phone camera is presumed to be an ideal lens. For the example shown, the distance D1, the distance from the front surface of element 500 to the entrance to the phone's camera, can be ˜30 mm, which the distance D2, total track, can be ˜34 mm.

The optical performance of the lens of FIG. 5 can be better appreciated from FIG. 7, which shows a geometric map of the lens' modulation transfer function (MTF) at 220 cyc/mm frequency, as compared to FIG. 8, which shows the geometric MTF of a rotationally symmetric lens system having the same technical specifications other than features of the present invention. In particular, the advantages of the present invention can be understood most easily by comparing the edges of the field view. Those skilled in the art will understand that green zones depict a higher MTF value, and thus the green zones at the edges of FIG. 7, compared to the blue zones at the edges of FIG. 8, demonstrates the performance improvement.

Similarly, FIGS. 9 and 10 are grid distortion maps for, respectively, the lens of FIG. 5 and a conventional rotationally symmetric lens. For the example shown, grid distortion for the lens of FIG. 9 is less that 0.63%, while the lens of FIG. 10 shows a distortion of less than 0.78%. While both values are acceptable in some instances, the benefits of the present invention offer significant value in more demanding applications.

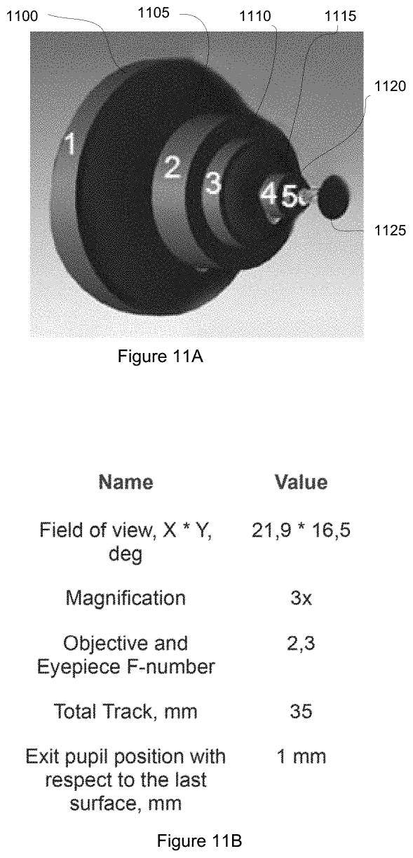

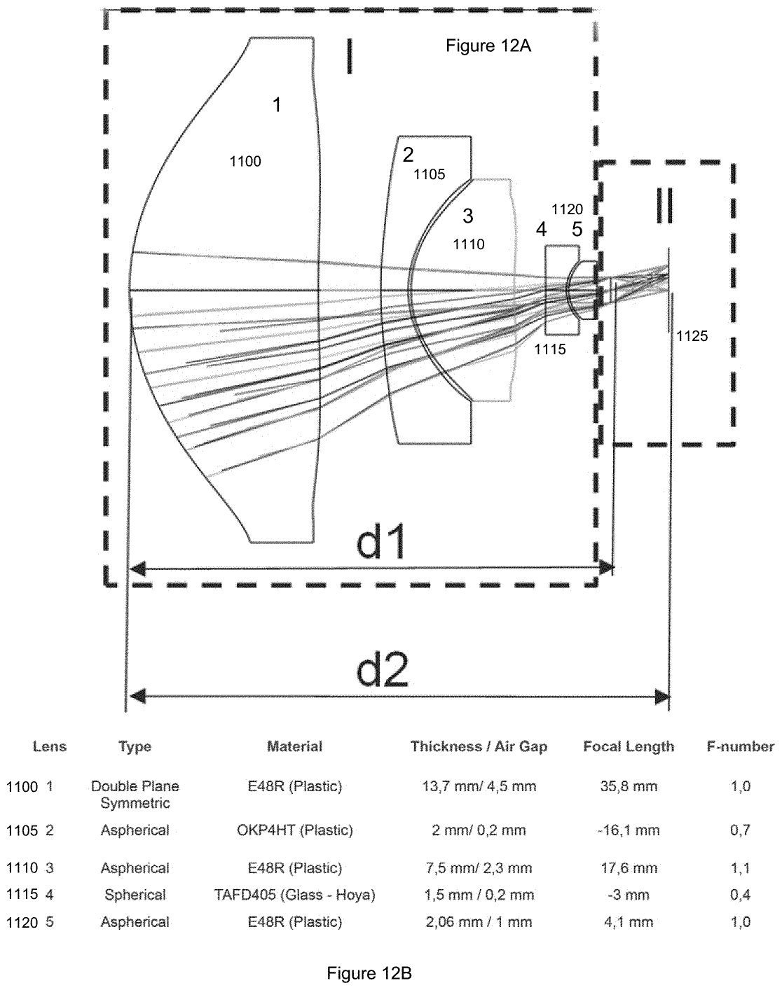

A Galileo type afocal telescopic system in accordance with an aspect of the present invention, together with its performance characteristics, are shown in FIGS. 11A-14. The lens system of FIG. 11, shown in cross-sectional ray path view in FIG. 12A, again comprises two parts, both with positive optical power. Elements 1100-1110 comprise the Objective, while elements 1115-1120 comprise the Eyepiece part, to project an image onto sensor 1125. Element 1100 is a double plane symmetric lens, while the other four elements are rotationally symmetric lenses. For the design shown, the field of view along the X axis is 21.9 degrees, and the field of view along the Y axis is 16.5 degrees. The magnification is 3×, with an f-number of 2.3. The total track is 35 mm, with a one mm distance from the last lens surface to the exit pupil. As before, those skilled in the art will recognize that these characteristics are exemplary and not limiting, and are provided simply to aid in understanding the benefits of the present invention as well as the ease of implementation.

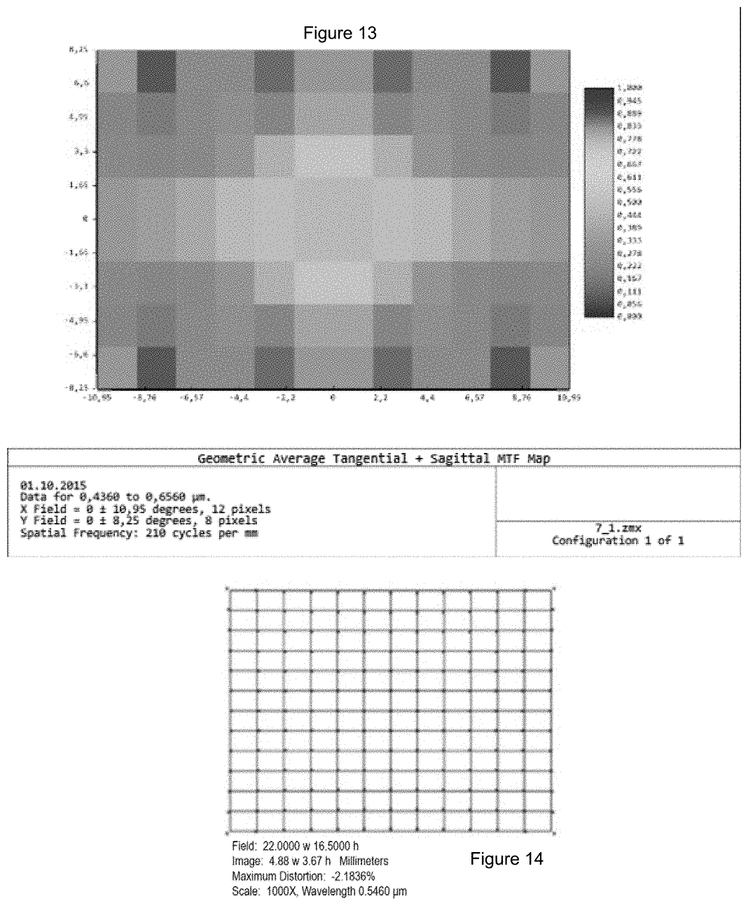

Referring particularly to FIG. 12A, the relationship between the afocal lens of one aspect of the present invention, indicated as portion I, and a camera with an existing lens such as a smart phone camera indicated as portion II, can be better appreciated. The table of FIG. 12B provides details regarding each element, similar to FIG. 6B. In the exemplary embodiment shown, the distance from the front surface of element 1 to the entrance to camera of portion II is ˜35 mm, with a total track of ˜39.2 mm. Performance information for the lens of FIG. 11 is shown in FIGS. 13-14, where FIG. 13 illustrates geometric MTF and FIG. 14 illustrates grid distortion, similar to FIGS. 7 and 9.

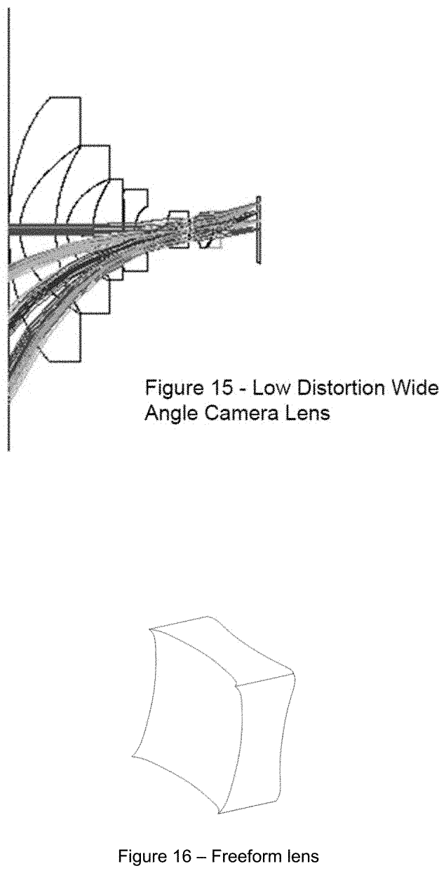

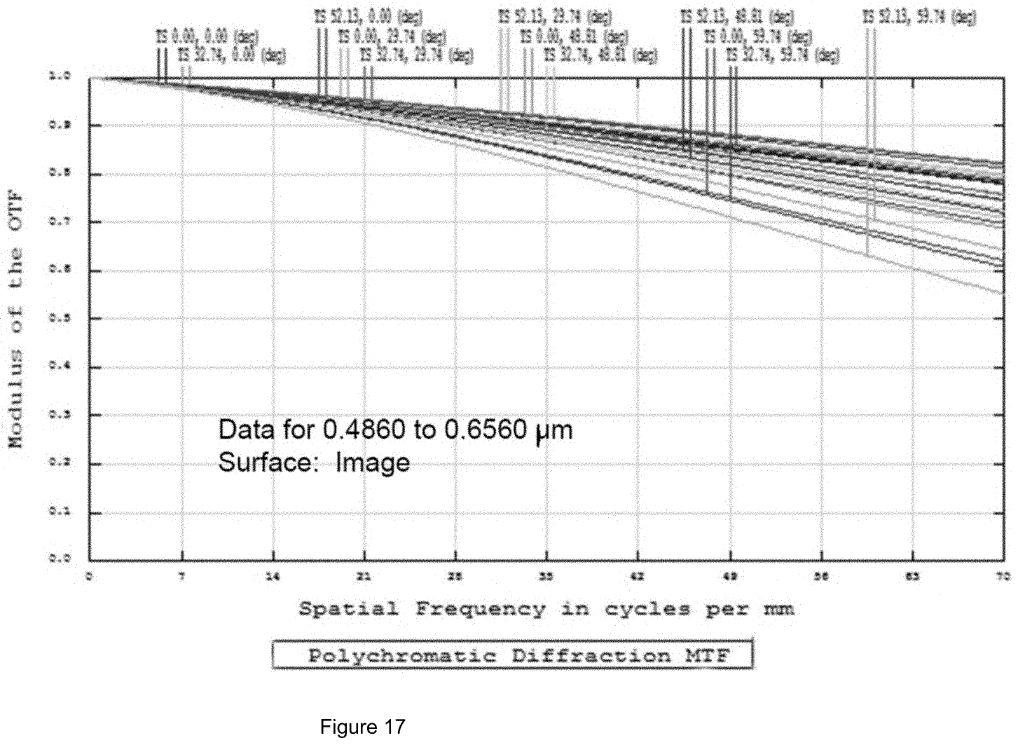

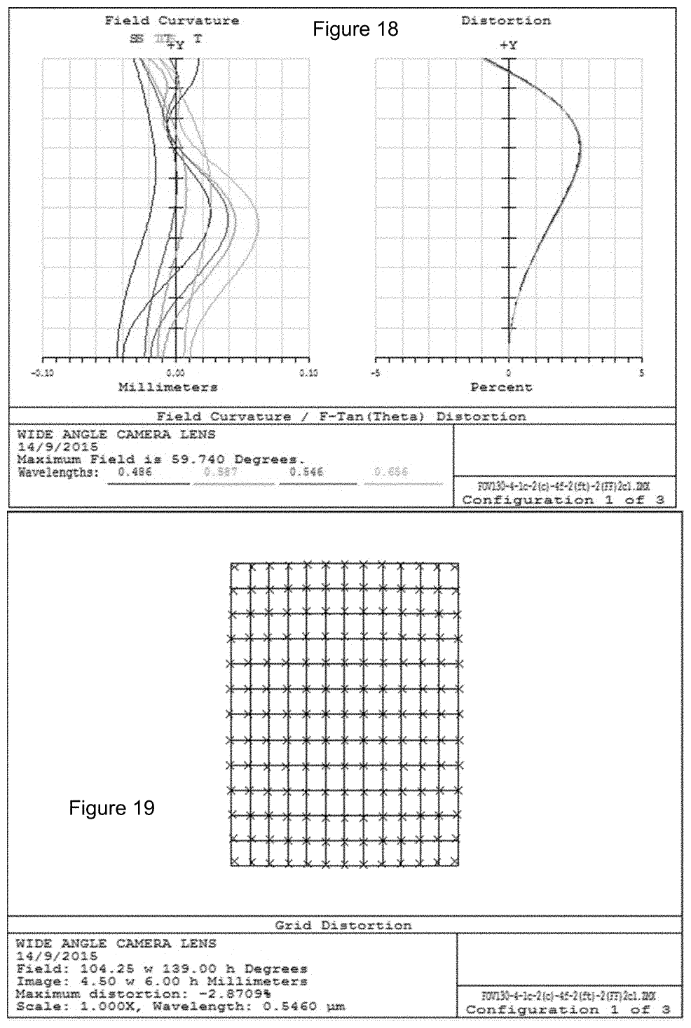

While the afocal lenses of FIG. 5 and FIG. 11 are telescopic, the present invention can also apply to wide angle lenses. Thus, shown in FIG. 15 is a cross-sectional ray plot of a wide angle lens system comprising six lens elements, where the sixth element is configured with double plane symmetry. The performance of such a lens system, again designed as an attachment to an existing camera such as a camera integrated into a smart phone, can be appreciated from the plot of FIG. 17, which shows polychromatic diffraction MTF, FIG. 18, which illustrates field curvature in both millimeters and percent, and FIG. 19 which is a plot of grid distortion.

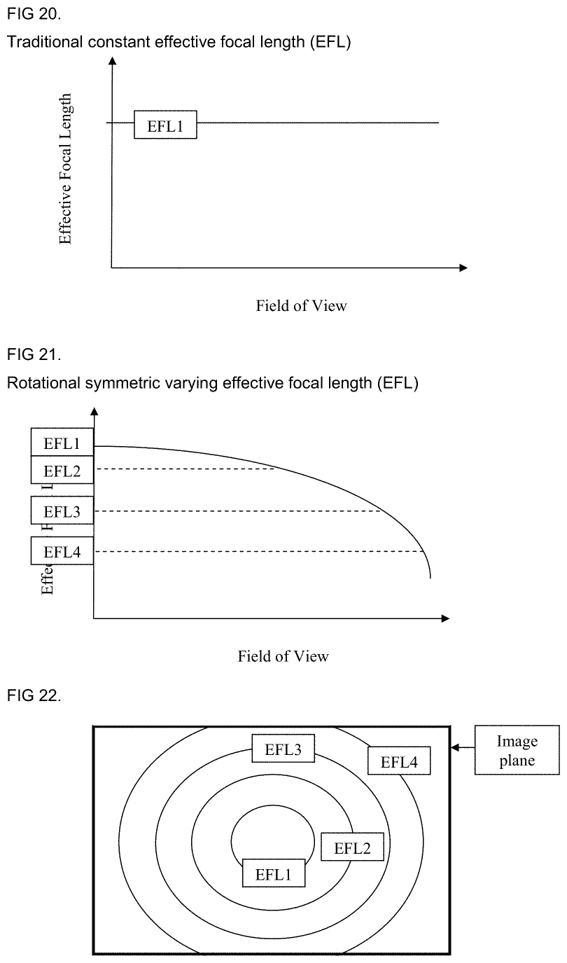

Traditional optical systems have a constant effective focal length throughout the whole field of view of the sensor as in FIG. 20. FIG. 21 illustrates an optical system where the effective focal length changes depending on the location within the field of view on the sensor. The relationship defining this change in effective focal length can be linear, a polynomial or an equation that varies only with the distance of the coordinate from the optical center of the image plane. In the example shown in FIG. 22, the effective focal length changes over a plurality of zones with the distance from the center on a lens having rotational symmetry. In some embodiments the image projected on the sensor is more oval than circular and thus the shape is defined by an axis or foci rather than the center of a circle.

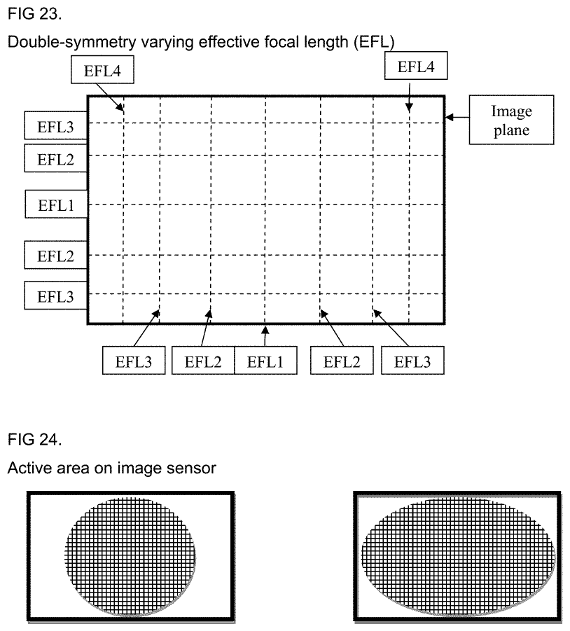

Another way that the effective focal length can change to reduce the perspective aberration using double symmetry freeform lenses is to have the same or different rates of change parallel to the X-axis and Y-axis. In this manner, lines parallel to the X-axis or Y-axis in the object plane remains straight in the image plane when captured by the sensor as show in FIG. 23. While the double plane symmetry lens elements described above typically have one or more surfaces described by an X-Y polynomial, free form lenses having one or more surfaces configured according to Zernike or Chebyshev polynomials can also provide significant benefits over rotationally symmetric lens systems, as discussed in greater detail hereinafter.

FIG. 24 illustrates a conventional image circle for a larger than 180 deg FOV lens. The resultant image does not fully utilize the whole sensor and thus obtain the full pixel count. A double symmetry or other shape of freeform lens allows a non-circular image to be projected on the sensor to increase the number of usable pixels.

Free form lenses in accordance with different aspects of the invention can also provide significant benefits when compared with conventional, rotationally symmetric lens systems. As discussed in greater detail below, embodiments reflecting different aspects of the present invention can achieve ultra-wide, or panoramic, fields of view, or can provide a lens system with high MTF as well as high Strehl while at the same time achieving small track length, or can provide a lens system utilizing a hybrid free form lens and suitable for mobile applications with a very low f-number and short track length configured to be mated to a large sensor, or can provide a lens system suitable for mobile applications with fewer lens elements and utilizing a free form lens with a diffractive surface defined by a Zernike polynomial, or can provide a non-imaging lens system suitable for time-of-flight applications and having a wide field of view with relatively uniform illumination, low stray light and low f-number at a chosen frequency such as the infrared or near-infrared range.

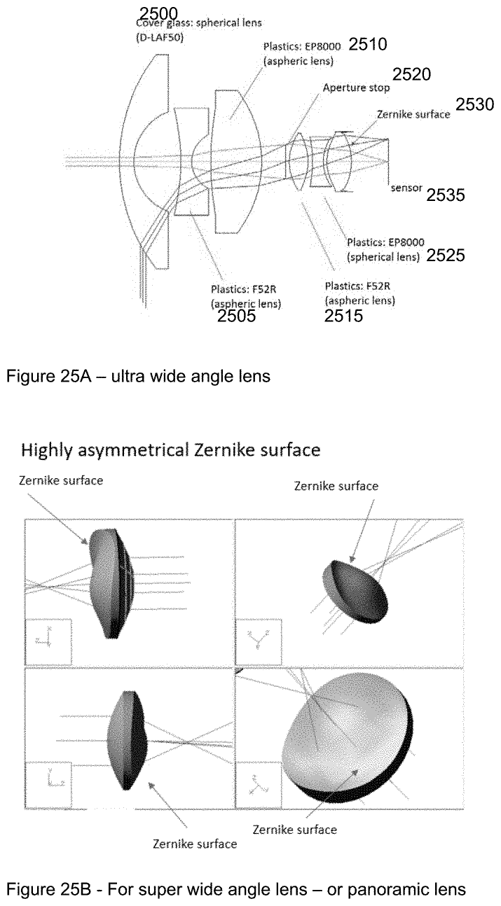

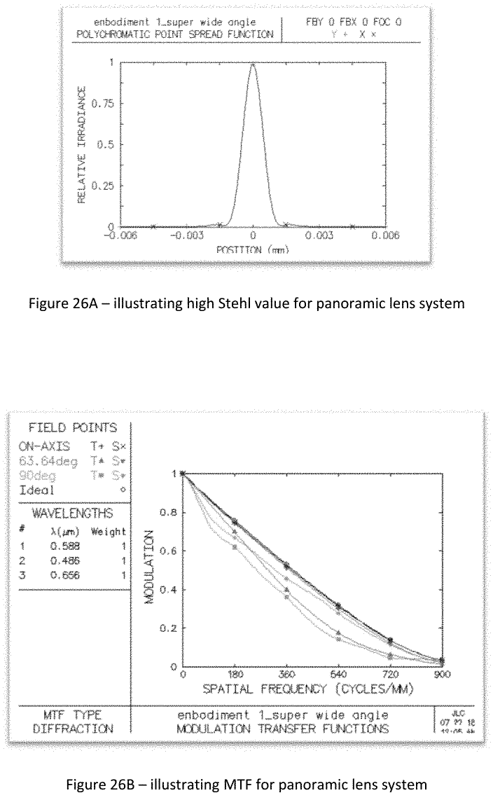

Turning next to FIGS. 25A and 25B, an embodiment of an aspect of the invention different from the double plane symmetry of FIGS. 5-7 can be better appreciated. More specifically, FIGS. 25A and 25B show, respectively, a lens system offering a panoramic or ultra wide field of view, and a free form lens element having a surface defined by a Zernike polynomial (a “Zernike surface”) for use in the lens system of FIG. 25.

Thus, the embodiment shown in FIG. 25A comprises a six element lens system in which any IR filter and the sensor cover glass have been omitted for clarity and simplicity. Going from object space to image space, the front element 2500 can comprise a spherical glass element of D-LAF50, followed by a plastic aspheric element 2505 of F52R, then a third aspheric element 2510 of EP8000 plastic, a fourth, aspheric element 2515 of F52R plastic with an aperture stop 2520 between the third and fourth elements, a fifth spherical element 2525 of EP8000 plastic, and, finally, a sixth, free form element 2530 comprised of, for example, F52R having a rear surface [closest to sensor 2535] defined by a Zernike polynomial. An exemplary Zernike surface of the sixth element can be better appreciated from FIG. 26. The sag Z of the Zernike surface of element 2530 is defined by the polynomial

$$z = \frac{{cvr}^{2}}{1 + \sqrt{1 - {cv}^{2} ( cc + 1 ) {r}^{2}}} + {\sum }_{i = 0}^{n} ( asi ) {Z}_{i}$$

where the coefficient CV is the curvature, CC is the conic constant, r is the radial coordinate, Zᵢ is the Zernike polynomial and the coefficients asᵢ are the corresponding Zernike coefficients. Those skilled in the art will recognize that there are several types of Zernike polynomials in the literature, including Standard Zernike, Fringe Zernike, Extended Fringe Zernike, etc. For the sake of clarity of communication, and to best conform with currently available experimental measurement and machines, the form of Zernike polynomial used herein is the fringe Zernike polynomial which has a total of 37 terms, the same as the Zernike polynomial implemented in Code V software. These 37 terms are defaulted in the simulation package, OSLO [Optics Software for Layout and Optimization, from Lambda Research.] The polynomial contains essentially two variables, radial coordinate ρ and the angle θ

Mathematically, the Zernike polynomials Z follow the equations

Zₙ^{m}(r,θ) =Rₙ^{m}(r)sin(mθ)

and

Zₙ^{-m}(r,θ)=Rₙ^{m}(r)cos(mθ)

where the radial polynomial R follows the equation

$${R}_{n}^{m} ( r ) = {\sum }_{k = 0}^{\frac{n - m}{2}} \frac{{( - 1 )}^{k} ( n - k ) !}{k ! ( \frac{n + m}{2} - k ) ! ( \frac{n - m}{2} - k )} * {r}^{n - 2 k}$$

and n=0,1,2, . . . is the degree of the Zernike polynomials and m=−n ton is the order.

The table, below, provides an illustration of the implementation of the Zernike polynomials used in various embodiments of the present invention.

| | | No. of terms | |
|---|---|---|---|
| n (degree) | m (order) | (sum of total terms) | |
| 0 | 0 | 1 | (1) |
| 1 | −1, 0, 1 | 3 | (4) |
| 2 | −2, −1, 0, 1, 2 | 5 | (9) |
| 3 | −3, −2, −1, 0, 1, 2, 3 | 7 | (16) |
| 4 | −4, −3, −2, −1, 0, 1, 2, 3, 4 | 9 | (25) |
| 5 | −5, −4, −3, −2, −1, 0, 1, 2, 3, 4, 5 | 11 | (36) |

The main lens characteristics of the lens system of FIG. 25 are shown in the table below.

| items | Specification | items | specification |
|---|---|---|---|
| Field of view | 180 deg. | Image circle | 1.0 mm |
| f-number | f/1.8 | Effective focal | 0.34 mm |
| | | length | |
| Optical | High Strehl ratio | Wavelength | visible |
| performance | High MTF | | |
| Targeted | e.g., OV6922 | Total lens track | 5.0 mm |
| sensor | | (TTL) | |
| | | IR filter | None |
| Lens | 6P | Sensor cover glass | None |
| configuration | (one ff lens) | | |

The Zernike surface on the sixth element 2530 is characterized by the coefficients in the following table, where the higher numbered coefficients 15-37 are all 0.

| Zernike items | Coefficient value |
|---|---|
| As2 | 0.0136922948189 |
| (symmetrical along y axis) | |
| As3 | 0.0425291689052 |
| (symmetrical along x axis) | |
| As4 | 0.0794668945033 |
| (tilted double-plane | |
| symmetry) | |
| As5 | 0.1119250770219 |
| (double-plane symmetry) | |
| As6 | 0.1271601177546 |
| (symmetrical along y axis) | |
| As7 | 0.1194655346897 |
| (symmetrical along x axis) | |
| As8 | 0.0932632561482 |
| (axial rotational symmetry) | |
| As9 | 0.0598535697447 |
| (3-fold symmetry) | |
| As10 | 0.0307579423167 |
| (3 fold symmetry) | |
| As11 | 0.0120233358463 |
| (tilted double-plane | |
| symmetry) | |
| As12 | 0.0032034184495 |
| (double-plane symmetry) | |
| As13 | 0.0004389367963 |
| (symmetry along y axis) | |
| As14 | 1.0e−07 |
| (symmetry along x axis) | |

A panoramic lens system designed to create a camera-quality image will preferably have a high MTF, high Strehl, low stray light and low f-number. For the embodiment shown in FIGS. 25A-25B, the MTF and Strehl ratio can be appreciated from FIGS. 26A-26B. FIG. 26A illustrates that the lens system of FIG. 25A has an on-axis point spread ratio, or Strehl value, that approaches 1.0, close to the diffraction limit. FIG. 26B shows that the lens system of FIG. 25A has a very high MTF value with spatial frequency even at values greater than 360 Ip/mm.

In addition, for implementations such as mobile, where available volume is limited, low track length is highly desirable. By the use of a free form lens a tilted optical axis, as provided by the Zernike surface detailed above, enables such lens characteristics to be achieved. Those same characteristics cannot be achieved by conventional rotationally symmetric lenses, even when aspheric elements are incorporated into the lens system.

Some, though not all, of the desirable characteristics of the above-described panoramic lens system can be achieved with the use of a free form lens having double plane symmetry. Two types of double plane symmetry can be used, either non-rotated or rotated, each of which uses only four Zernike terms. The below table illustrates one example, where the Zernike items not listed all have a coefficient value of 0.

| Zernike items | Coefficient value |
|---|---|
| As2 | 0.0136922948189 |
| (symmetrical along y axis) | |
| As3 | 0.0425291689052 |
| (symmetrical along x axis) | |
| As4 | 0.0794668945033 |
| (tilted double-plane symmetry) | |
| As5 | 0.1119250770219 |
| (double-plane symmetry) | |
| As6 | 0.1271601177546 |
| (symmetrical along y axis) | |
| As7 | 0.1194655346897 |
| (symmetrical along x axis) | |
| As8 | 0.0932632561482 |
| (axial rotational symmetry) | |
| As9 | 0.0598535697447 |
| (3-fold symmetry) | |
| As10 | 0.0307579423167 |
| (3 fold symmetry) | |
| As11 | 0.0120233358463 |
| (tilted double-plane symmetry) | |
| As12 | 0.0032034184495 |
| (double-plane symmetry) | |
| As13 | 0.0004389367963 |
| (symmetry along y axis) | |
| As14 | 1.0e−07 |
| (symmetry along x axis) | |

If non-rotated, the Zernike polynomial can be generalized to f(ρ)*cos(2*θ)+g(ρ), while the rotated version can be generalized to f(ρ)*sin(2*θ)+g(ρ) where the additional g(ρ) term is used to provide correction for distortion, piston, defocus/field curvature, and/or first, second, third, fourth order spherical aberration. In the foregoing generalized equations, f(ρ)=sqrt(x²+y²). For embodiments not using double plane symmetry, the Zernike equations are similar but the (2*θ) terms will typically be replaced with (3*θ), (4*θ), or (n*θ).

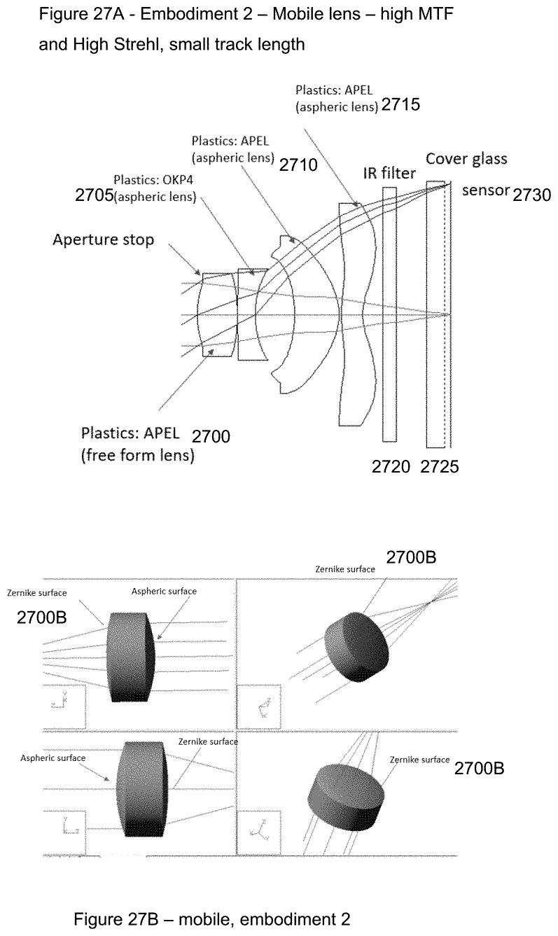

Referring next to FIGS. 27A-27B, an embodiment of the invention comprising a four element lens system suitable for mobile applications is shown where the front element, closest to object space, has a free form rear surface, preferably defined by a Zernike polynomial. An aperture stop, not shown, can be implemented in front of the free form element 2700. The element 2700 can be cast from APEL plastic. A second element 2705 can be an aspheric lens comprised of OKP4 plastic, while third and fourth elements, 2710 and 2715 respectively, can be aspheric elements cast or otherwise fabricated from APEL plastic. An IR filter and sensor cover glass, 2720 and 2725 respectively, can be interposed between the rear element 2715 and a sensor 2730.

The free form element 2700, and particularly its rear free form surface 2700B, can be better appreciated from FIG. 27B. The Zernike coefficients for that surface can be seen in the table below. As with the table above, coefficient values not shown are zero for this example.

| Zernike items | Coefficient value |
|---|---|
| AS0 | 0.1013048202697 |
| As3 | −0.0025669021829 |
| (axial rotational symmetry) | |
| As8 | −0.0082779444441 |
| (axial rotational symmetry) | |
| As15 | −0.0009368935293 |
| (axial rotational symmetry) | |
| As16 | −0.0000667269567 |
| (4-fold symmetry) | |
| As35 | −0.0001103585513 |
| (axial rotational symmetry) | |
| As36 | 1.7886778379e−06 |
| (axial rotational symmetry) | |

From the above coefficients it can be appreciated that the free form surface on element 2700 is only slightly asymmetrical. The major characteristics of the lens system of FIG. 27A are summarized in the following table.

| Item | Specification | Item | Specification |
|---|---|---|---|
| Field of view | 66 deg. | Image circle | 4.4 mm |
| f-number | f/2.5 | Effective focal | 2.57 mm |
| | | length | |
| Optical | High Strehl ratio | Wavelength | visible |
| performance | High MTF | | |
| Targeted | ~1/4″ sensor | Total lens track | 2.33 mm |
| sensor | | (TTL) | |
| | | (not included IR | |
| | | cut/cover lens) | |
| | | IR cut lens thickness | 0.22 mm |
| Lens | 4P | Sensor cover lens | 0.3 mm |
| configuration | (one free lens) | thickness | |

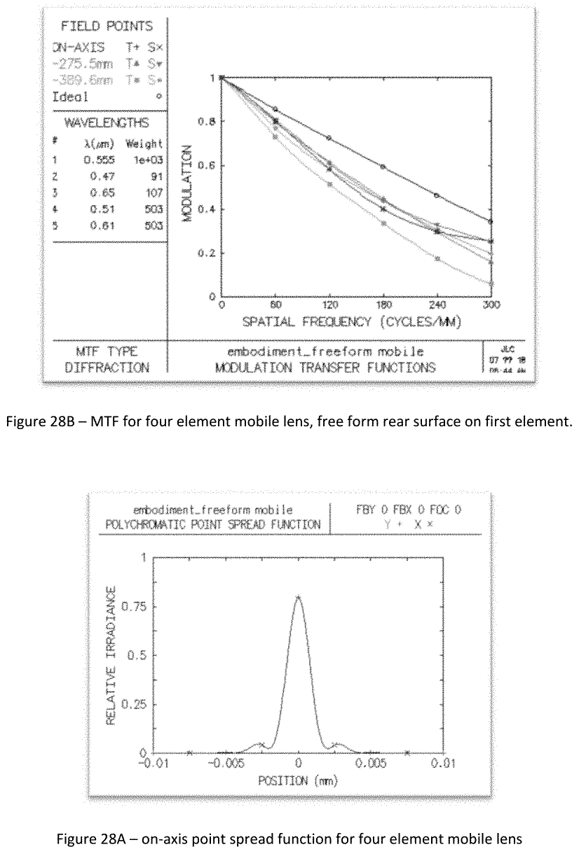

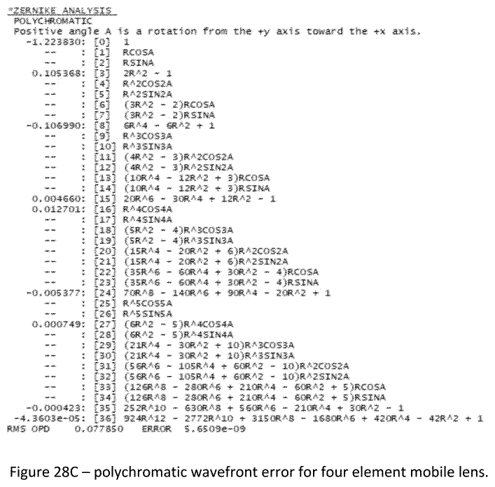

Notable among the above characteristics is the extremely short track length together with a high Strehl ratio, close to the diffraction limit, as well as a high MTF. It will also be appreciated that a high Strehl ratio implies that the lens system is relatively tolerant of alignment error during assembly. Shown in FIGS. 28A-28B are the plots for Strehl ratio and MTF for the lens system of FIG. 27A. FIG. 28C shows the corresponding polychromatic wavefront error for the system of FIG. 27A. One can see that there are only a few residual terms, i.e., non-zero terms, for the wavefront error, namely the terms 0, 3, 8, 15, 16, 24, 27, 35, and 36. Also, from the result, one can understand that use of the 16^{th} term of the Zernike polynomial in the free form surface helps reduce error. A more complicated free form surface can be described if the 37^{th} term is included. Note that the free form surface used in this embodiment is with the terms 0, 3, 8, 14, 16, 24, 25, and 36, of the Zernike polynomial for forming the corresponding sag surface. It will be appreciated that, while one free form surface is described for FIG. 27A, multiple such free form surfaces can be used in this or any of the embodiments described herein.

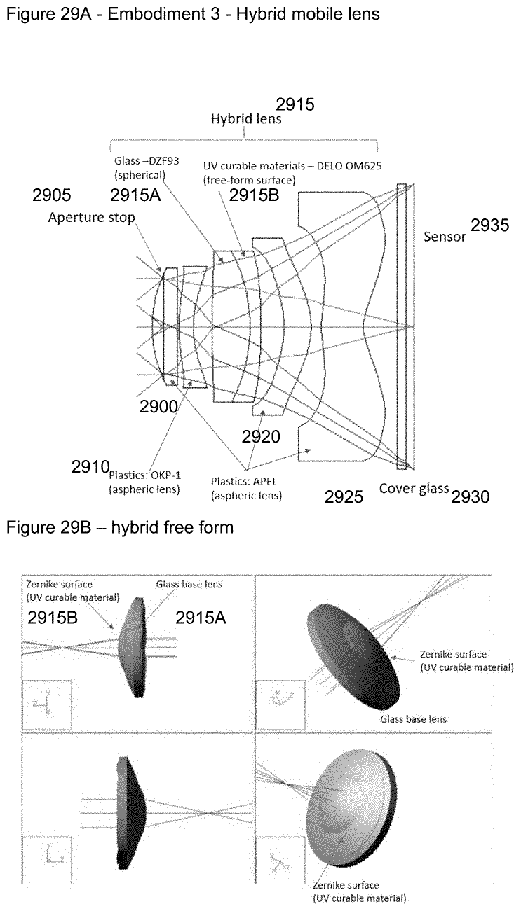

Referring next to FIGS. 29A, a five element lens system comprising a hybrid lens with a free form surface is shown. FIG. 29B shows the hybrid free form element in greater detail. Starting from object space, the first element 2900 can comprise an aspheric element of APEL plastic. An optional aperture stop 2905 can be placed in front of the first element 2900. A second element 2910 can be an aspheric element of OKP-1 plastic. The third element 2915 is preferably a hybrid element having an aspherical glass base portion 2915A and a UV curable portion 2915B affixed to the back thereof to form a doublet. The glass portion can have, in at least some embodiments, a high refractive index, for example, greater than 2.0. The portion 2915B can be made, for example, from DELO OM625 or similar, and is configured as a free form surface. The hybrid of high refractive index glass and and properly chosen materials for portion 2915B, chromatic aberration can be reduced. Fourth and fifth elements, 2920 and 2925 respectively, are both preferably aspherical and comprised of APEL plastic. Optional cover glass 2930 and sensor 2935 are shown to the right of the rear element 2925. The hybrid lens element 2915 can be better appreciated from FIG. 29B. The lens system of FIG. 29A is particularly well suited to mobile applications involving a large sensor and a low f-number. In addition, the hybrid element permits reduction of the number of elements and the corresponding reduction in total track length. The major characteristics of the lens system of FIG. 29A can be appreciated from the table, below.

| items | Specification | items | specification |
|---|---|---|---|
| Field of view | 78 degrees | Image circle | 6.8 mm |
| f-number | f/1.6 | Effective focal | 3.66 mm |
| | | length | |
| Optical | typical | Wavelength | visible |
| performance | | | |
| Targeted | ~1/2″ sensor | Total lens track (TTL) | 5.55 mm |
| sensor | | (not included IR | |
| | | cut/cover lens) | |
| | | IR cut lens thickness | none |
| Lens | 5P | Sensor cover lens | 0.21 mm |
| configuration | (one hybrid | thickness | |
| | ff lens) | | |

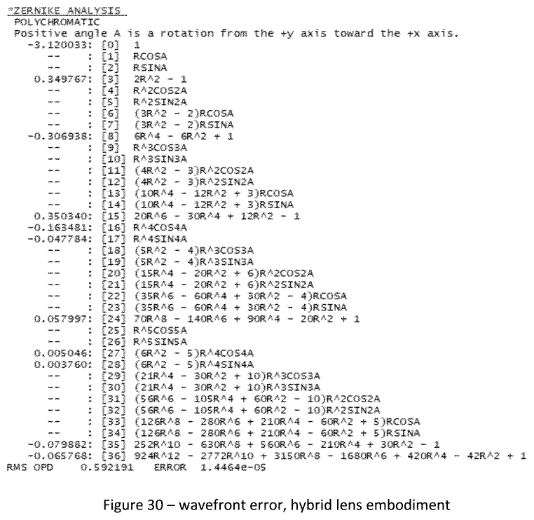

Exemplary Zernike coefficients for the surface of the portion 2915B can be seen in the below table. On-axis wavefront error for the embodiment of FIG. 29A can be seen in FIG. 30.

| Zernike items | Coefficient value |
|---|---|
| AS0 | 0.120978648737 |
| As1 | 0 |
| As2 | 0 |
| As3 | −0.0522597388653 |
| (axial rotational symmetry) | |
| As4 | 0 |
| As5 | 0 |
| As6 | 0 |
| As7 | 0 |
| As8 | −0.0124025850796 |
| (axial rotational symmetry) | |
| As9 | 0 |
| As10 | 0 |
| As11 | 0 |
| As12 | 0 |
| As13 | 0 |
| As14 | 0 |
| As15 | −6.3066102817e−06 |
| (axial rotational symmetry) | |
| As16 | −0.0002746940069 |
| (4-fold symmetry) | |
| As17 | 0 |
| As18 | 0 |
| As19 | 0 |
| As20 | 0 |
| As21 | 0 |
| As22 | 0 |
| As23 | 0 |
| As24 | 0 |
| As25 | 0 |
| As26 | 0 |
| As27 | −0.0008551477388 |
| (4-fold symmetry) | |
| As28 | −0.0004305281959 |
| (4-fold symmetry) | |
| (rotated) | |
| As35 | 0.0001639140541 |
| (axial rotational | |
| symmetry) | |
| As36 | −0.0002516255354 |
| (axial rotational | |
| symmetry) | |

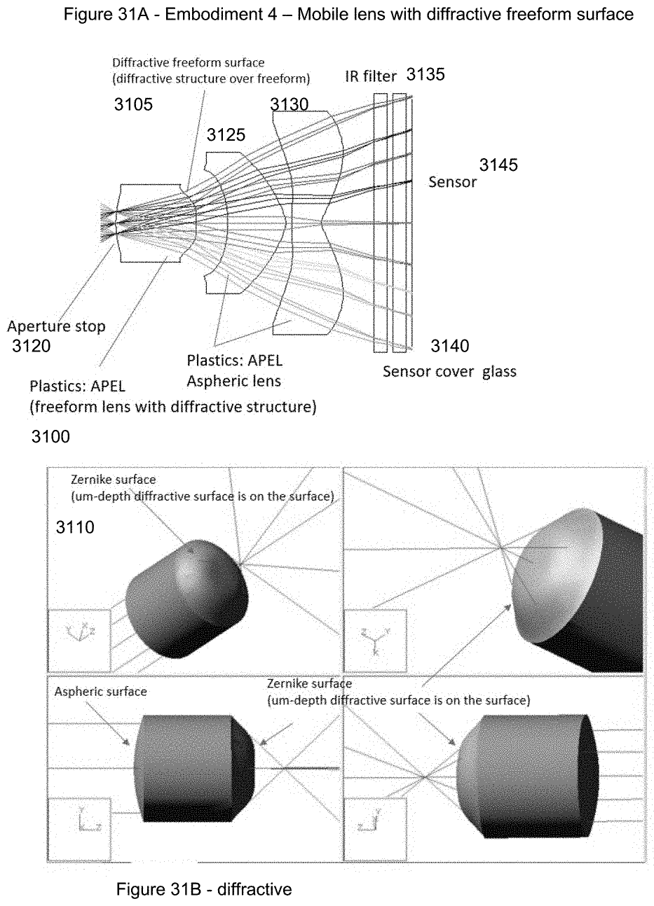

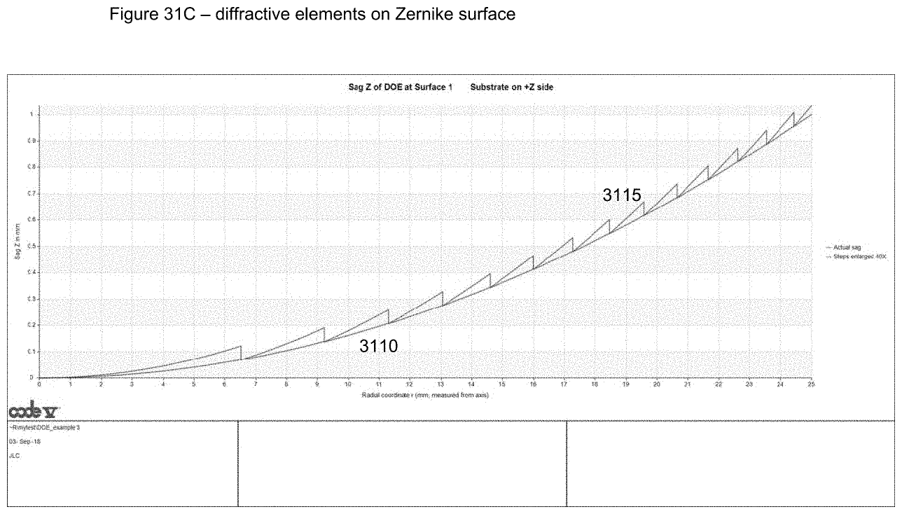

Referring next to FIGS. 31A-31B, an embodiment of an aspect of the invention is shown comprising a three element lens system suitable for use in mobile applications. A first element 3100 having a front aspheric surface and a rear free form surface 3105 can be comprised of APEL plastic. The rear surface 3105 is freeform and defined by a Zernike polynomial, with a micrometer diffractive surface 3110 over the freeform structure as shown in FIG. 31C. The diffractive surface 3110 comprises a plurality of steps 3115. An optional aperture 3120 may be disposed in front of the first element. Second and third elements, 3125 and 3130 respectively, can be aspherical and comprised of APEL plastic. To the right of the element 3130 are shown an IR filter 3135, sensor cover glass 3140, and sensor 3145.

The first element 3100 can be better appreciated from FIG. 31B, where the aspheric front is shown and the free form Zernike rear surface is also shown. Again, the diffractive surface 3110 is shown in FIG. 31C. The major characteristics of the lens system of FIG. 31A can be seen in the below table.

| Item | Specification | Item | Specification |
|---|---|---|---|
| Field of view | 60 degrees | Image circle | 4.4 mm |
| f-number | f/2.2 | Effective focal length | 0.81 mm |
| Optical | typical | Wavelength | visible |
| performance | | | |
| Targeted | ~1/4″ sensor | Total lens track (TTL) | 3.39 mm |
| sensor | | (not included IR | |
| | | cut/cover lens) | |
| | | IR cut lens thickness | 0.22 mm |
| Lens | 3P | Sensor cover lens | 0.22 mm |
| configuration | (one diffractive | thickness | |
| | ff lens) | | |

The corresponding coefficients of the exemplary Zernike surface can be seen in the table below.

| Zernike items | Coefficient value |
|---|---|
| AS0 | 0.6996998910551 |
| As1 | 0 |
| As2 | 0 |
| As3 | 0.1645374045694 |
| (axial rotational symmetry) | |
| As4 | 0 |
| As5 | 0.0063380471583 |
| (double-plane symmetry) | |
| As6 | 0 |
| As7 | 0 |
| As8 | 0.0186133969931 |
| (axial rotational symmetry) | |
| As9 | 0 |
| As10 | 0 |
| As11 | 0 |
| As12 | 0 |
| As13 | 0 |
| As14 | 0 |
| As15 | 0.0480000314748 |
| (axial rotational symmetry) | |
| As16 | 0 |
| As17 | 0 |
| As18 | 0 |
| As19 | 0 |
| As20 | 0 |
| As21 | 0 |
| As22 | 0 |
| As23 | 0 |
| As24 | 0 |
| As25 | 0 |
| As26 | 0 |
| As27 | 0 |
| As28 | 0 |
| As29 | 0 |
| As30 | 0 |
| As31 | 0 |
| As32 | 0 |
| As33 | 0 |
| As34 | 0 |
| As35 | 0 |
| As36 | 0 |

The diffractive surface on the free form surface follows a phase distribution in even power of the radial coordinate, r, according to the following equation.

$$ϕ ( r ) = dor \frac{2 π}{{λ}_{0}} ( df 0 + df 1 {r}^{2} + df 2 {r}^{4} + df 3 {r}^{6} + df 4 {r}^{8} + … )$$

$$where$$

$${r}^{2} = {x}^{2} + {y}^{2}$$

where the corresponding coefficients are:

| # | items | Specification |
|---|---|---|
| 1 | Design wavelength | 555 nm |
| 2 | Diffractive coefficient of r\hat{ }0 | 0 |
| 3 | Diffractive coefficient of r\hat{ }2 | 0 |
| 4 | Diffractive coefficient of r\hat{ }4 | 2.5907880930645 |
| 5 | Diffractive coefficient of r\hat{ }6 | 4.162625670048 |
| 6 | Diffractive coefficient of r\hat{ }8 | −38.4979467924599 |
| 7 | Diffractive coefficient of r\hat{ }10 | 50.7079879454258 |

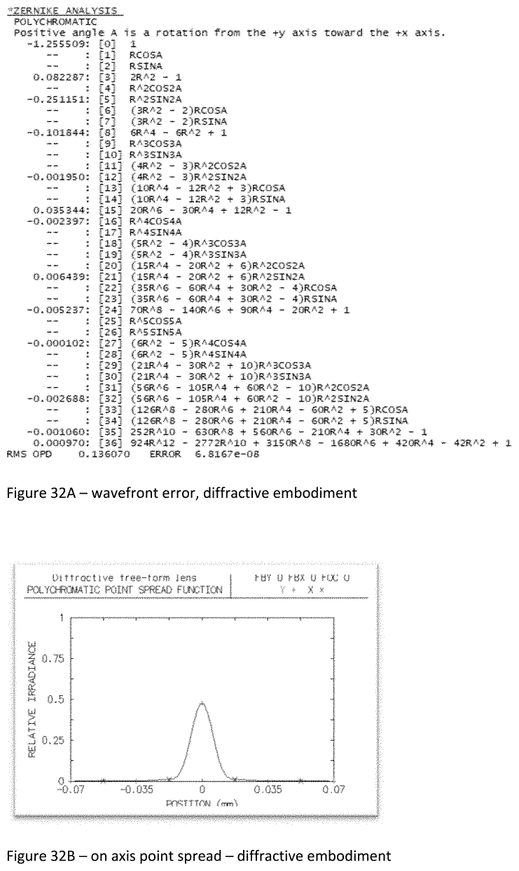

Turning next to FIGS. 32A and 32B, on-axis wavefront error and on-axis point spread, respectively, can be appreciated for the design of FIG. 31A. It will be appreciated that, while the diffractive surface is described for the above example as residing on the free form surface, the diffraction surface can reside on any other element although that may result in some changes to the coefficients in the above table. It will also be appreciated that several wavefront errors remain, in large measure because the example used herein to illustrate this aspect of the invention has been kept intentionally simple for purposes of clarity. If more free form elements are used, performance will be improved.

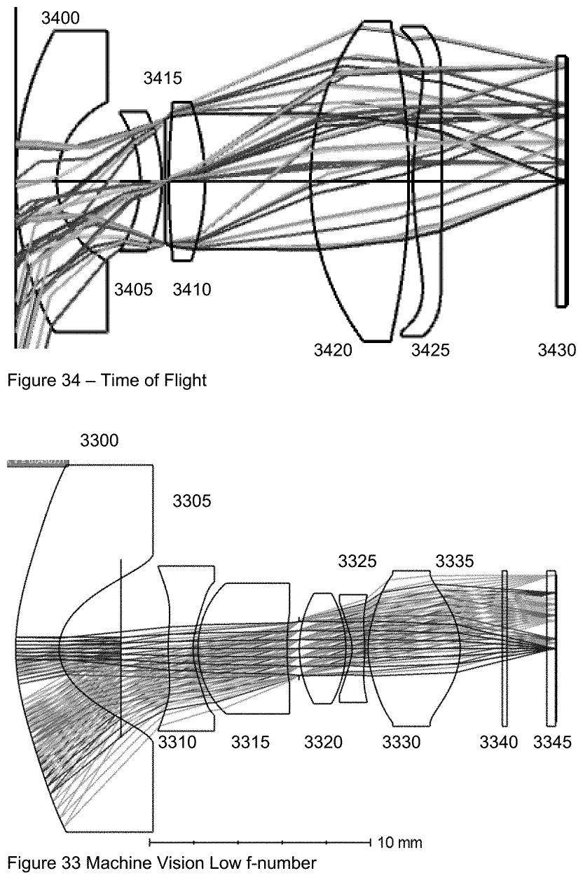

Turning next to FIG. 33, a still further aspect of the invention can be better appreciated. The embodiment of FIG. 33 is intended for use in machine vision applications, for example those found in various types of positioning systems. One class of such systems is used with autonomous and semi-autonomous vehicles, although other applications include identifying location of moveable equipment, personnel or patients within a hospital, detection by robots of impediments to movement or location of target objects, detection by drones of impediments to flight and proximity to landing zones, and numerous other tasks requiring the determination of the location of an object relative to the surrounding environment.

The machine vision lens illustrated in FIG. 33 can, in one embodiment and starting from object space, comprise a first aspheric meniscus element 3300, followed by an optional aperture 3305, in turn followed by an aspheric double concave element 3310, then an aspheric meniscus lens element 3315, a spherical double convex glass element 3320, a second aspheric meniscus element 3325, and finally a double convex element 3330 having a double plane symmetry rear surface 3335. The sensor and cover glass are shown at 3340 and 3345, respectively. Each of the elements except 3320 can be comprised of a suitable plastic as discussed for the foregoing embodiments. The double plane symmetry surface, for the illustrated embodiment, can be defined by a Zernike or Chebyshev polynomial in the manner shown hereinabove.

Turning next to FIG. 34, an aspect of the invention directed to time of flight sensing can be better appreciated. It will be appreciated by those skilled in the art that time of flight sensing is a specific type of machine vision. Time of flight can also be considered a non-imaging application even though a sensor is used for detection of the light impinging thereon to make the timing measurement. In some instances, time of flight sensing utilizes the infrared band, such as between 840 and 950 nanometers, where a freeform element is double plane symmetric and is defined by an X-Y polynomial. Such applications are discussed in the assignee's co-pending patent application filed on even date herewith and entitled Low Light Optical System Utilizing Double Plane Symmetry Defined by X-Y Polynomial, having the same inventors as the present application and assigned attorney's docket DO_016P. However, the optical elements can also be defined by Zernike or Chebyshev polynomials, as discussed at length hereinabove. Still further, time of flight sensing need not be confined to infrared wavelengths, and instead can utilize a much broader range. Depending upon the application, especially for freeform elements defined by Zernike or Chebyshev polynomials, time of flight sensing can use wavelengths from, for example, 350 nm to 2500 nm, with proper selection of the material for the optical elements to ensure appropriate transmittance. For many machine vision applications, and especially for time of flight (TOF) applications, low stray light is very important as well as low f-number. In addition, while some machine vision applications do not require a wide field of view (FOV), a wide FOV is preferred in many machine vision and TOF applications. For implementations using a wide field of view, very good releative illumination is also desirable. While “normal” cameras such as those in mobile phones are intended to create a planar image, TOF applications have a different objective. In TOF applications, the objective is obtain spatially correlated data representative of every object in the field of view, or what can be referred to as a depth map. To do so, TOF systems create synchronized signals over every pixel such that the time difference of light illuminating objects in the field of view and being reflected back to the sensor can be accurately determined, thus yielding the desired spatial information about those objects in the field of view.

Unlike most imaging applications, TOF applications typically include a light source. In such TOF applications, and many machine vision applications, providing a light source that enables good relative illumination across the field of view becomes important. While a lens system for the camera in a mobile phone operates acceptably with relative illumination at the edge of only 20% or 30% of the on-axis illumination, TOF applications require better off axis performance, and relative illumination is preferably at least 50% of axial illumination.

Stray light is another characteristic where TOF applications impose tighter requirements. While a mobile phone camera operates acceptably with a reduction ratio of 1.0×10\hat{ }−6, stray light for machine vision and TOF applications preferably is at least 1×10\hat{ }−7. Likewise, while the f-number for a mobile phone camera can be 1.8, or 2.0, 2.2, or even higher, the f-number for TOF applications is generally smaller, in the range of 1.0 to 1.6. The f-number for other types of machine vision applications can vary from the low f-number s desired for TOF applications to the higher f-numbers suitable for phone cameras, or even higher.

Still further, maintaining good optical performance for off-axis objects (or field points) is desirable for machine vision and TOF applications. It will also be appreciated by those skilled in the art that many, even all, of the foregoing desirable optical characteristics are equally desirable for other types of lenses, not just machine vision and TOF lenses.

Referring again to FIG. 34, an embodiment of a TOF lens system is shown. Starting from object space, a first element 3400 can be a spherical meniscus lens, followed by a spherical meniscus second element 3405 and a spherical double convex third element 3410. An optional aperture 3415 can be interposed between the second and third elements. A spherical double convex element 3420 follows the third element, and, as a fifth element 3425, a double plane symmetric meniscus lens element. All but the fifth element can be comprised of glass, while the fifth element is typically comprised of plastic. The image is formed on a sensor 3430. It will be appreciated that, depending upon the size of the lenses and the wavelength used, each of the elements can be of a different material, either all glass, all plastic, or some combination as illustrated by the example.

It will be appreciated by those skilled in the art that the various lens designs disclosed herein can be scaled up to match sensor size. Thus, while the sensors in some embodiments are shown as, approximately, one-fourth inch, one-third inch, or one-half inch, the invention can be equally well adapted to smaller or larger sensors, such as one-sixth inch sensors, one inch sensors, full frame sensors, or even larger. In terms of pixel count, such sensors can range from less than the eight megapixels typical of some cell phone cameras, all the way to fifty-five or more megapixels typical of some high end DSLR cameras.

Further, while fringe Zernicke polynomials have been described for ease of illustration of the invention, numerous other approaches using Zernike polynomials offer usable alternatives, as do Chebyshev and Extended X-Y polynomials.

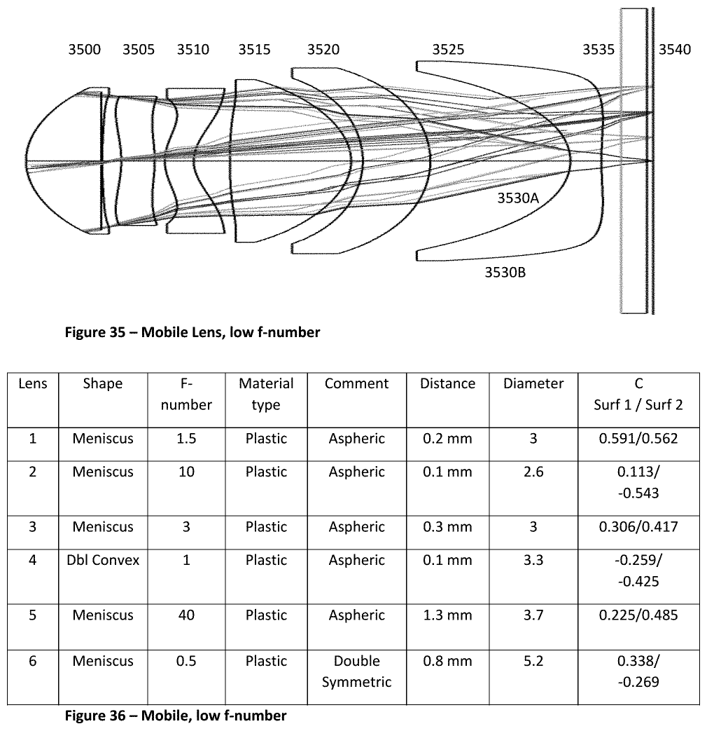

Turning next to FIG. 35, a lens system suitable for use in mobile phone cameras and using a lens element having double plane symmetry to provide an improved match between the object space and the image space (i.e., the rectangular sensor) can be better appreciated. In this embodiment, the double plane symmetric element has a freeform surface, or Z-sag, defined by an Extended X-Y polynomial, shown below, The Double Plane Symmetry surface is described through an Extended Polynomial equation:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y ) .$$

where z, x, y are cartesian coordinates of the surface, c is surface curvature, r is the surface radial coordinate, k is the conical constant, Aᵢ are polynomial coefficients, Σ(x,y) are polynomials.

Examples of Σ(x,y) are: X²Y², X⁴Y⁶, X⁸Y⁴, etc. Conical constant k in the illustrated embodiment is 0, but can be of any value as long as the term under the square root is greater than or equal to zero.

The above equation gives the freedom to separate x and y coordinates, and to define different coefficients for different XOZ and YOZ planes of the system.

In this case the lens system of FIG. 35 is designed for use in the visible light waveband although it will be appreciated by those skilled in the art that alternative implementations usable at different wavelengths such as near infrared, mid infrared or far infrared can be readily configured using the teachings herein.

As noted above, lens systems for mobile phone cameras typically operate with different constraints than lens systems for time of flight applications. More specifically, key characteristics of such camera lens systems are low distortion, reasonable field of view but not necessarily wide angle, acceptable f-number where lower is desirable but not always critical, and, perhaps most important, total track length. Typically, the total track length must be less than the Z-height of the phone so that the lens module does not stick out above the phone casing. Thus, shown in the Table, below, are key parameters for the lens system illustrated in FIG. 35. The lens elements are detailed in FIG. 36.

| Parameter | Value |
|---|---|
| Operating Waveband | 470 to 650 nm (Visible Region) |
| Field Of View | 75 degrees (Diagonal) |
| Optical Total Track | 5.5 mm |
| F-number | 1.4 |
| Effective Focal Length | 3.67 mm |
| Optical Distortion | 2% |
| Relative Illumination | 50% |
| Components | 5 Plastic (Aspherical) 1 Plastic |
| | (Double Plane Symmetric) |

Still referring to FIGS. 35 and 36, the lens system can be seen to comprise a first aspheric meniscus element 3500 (starting, as before, from object space), followed by a second, aspheric meniscus element 3505, and then a third aspheric meniscus element 3510. A fourth element 3515 in the illustrated embodiment is double convex, while a fifth element 3520 is again aspheric meniscus. The sixth element 3525 is meniscus with a double plane symmetry front and rear surfaces 3530A-3530B.

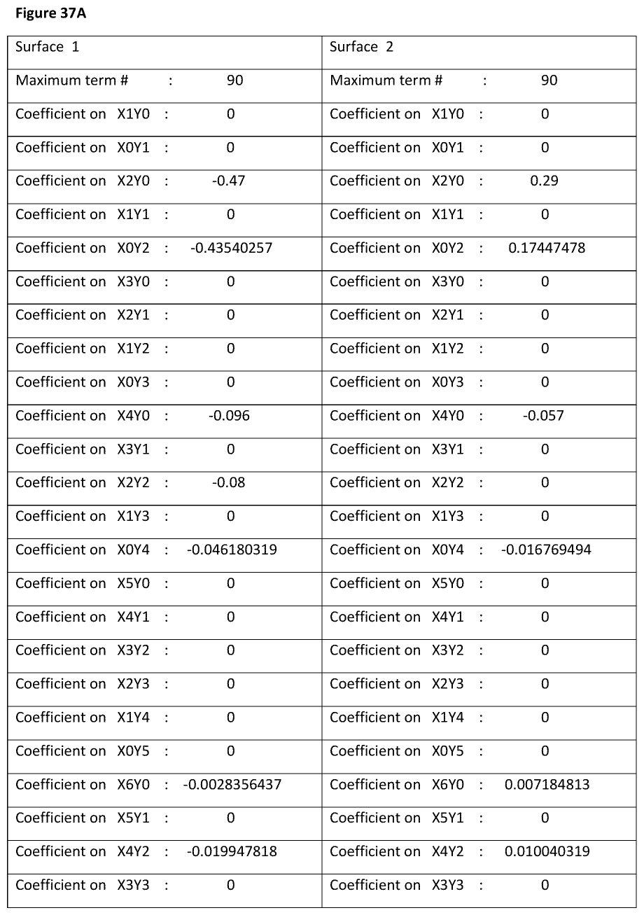

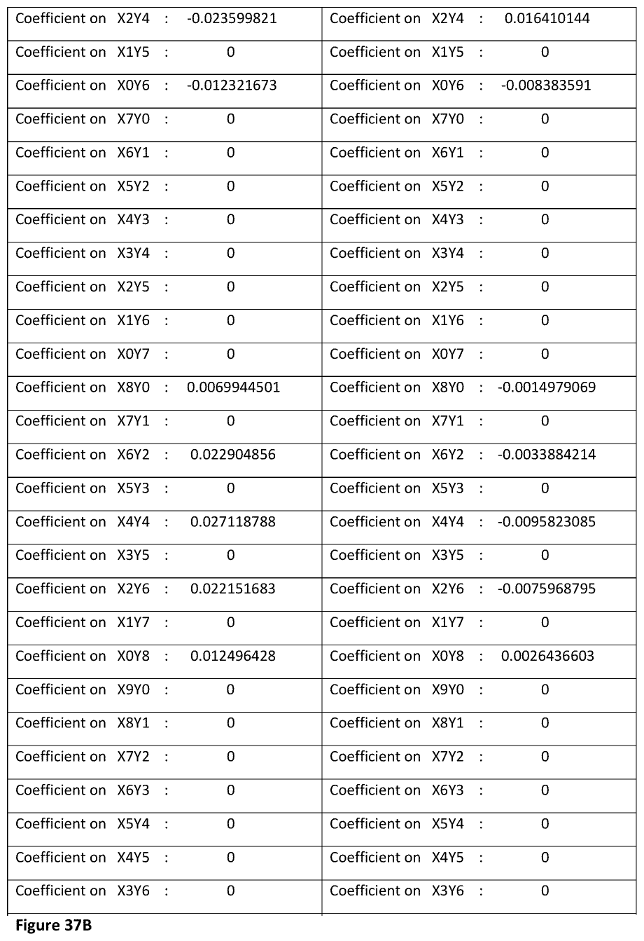

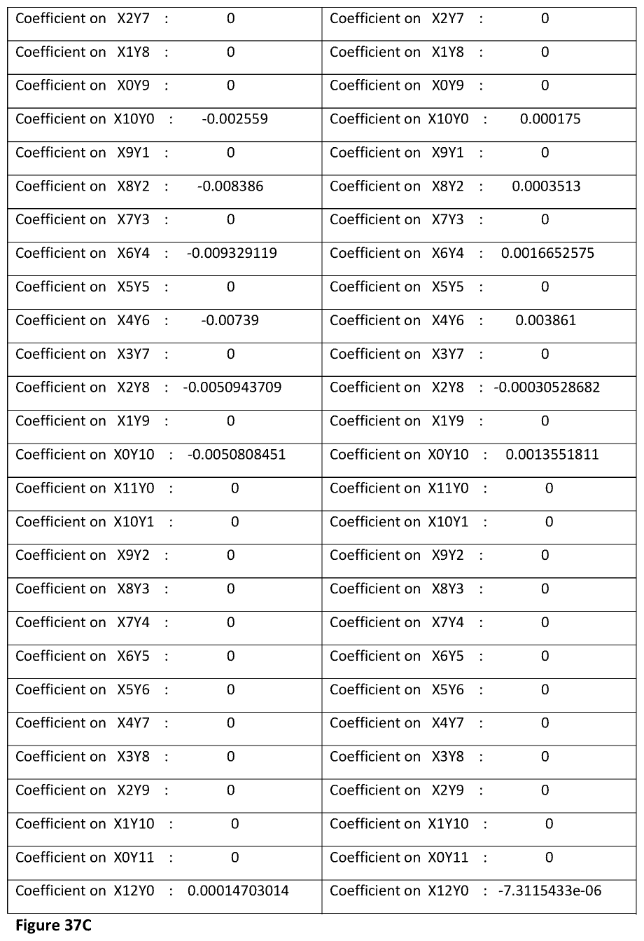

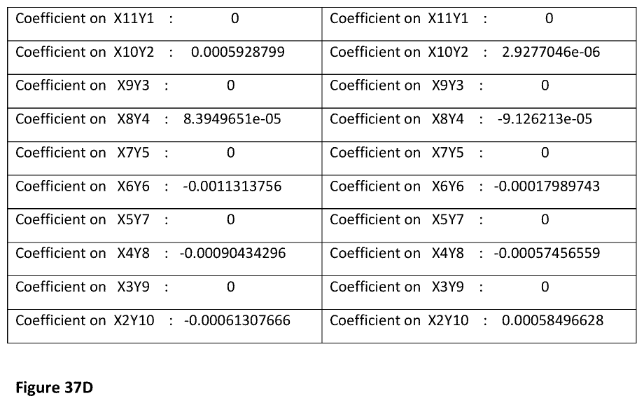

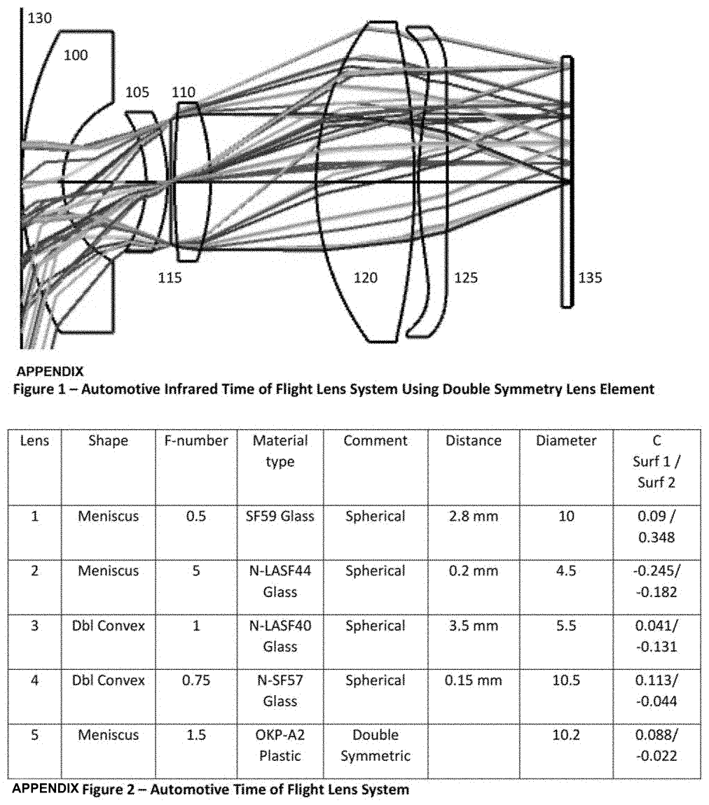

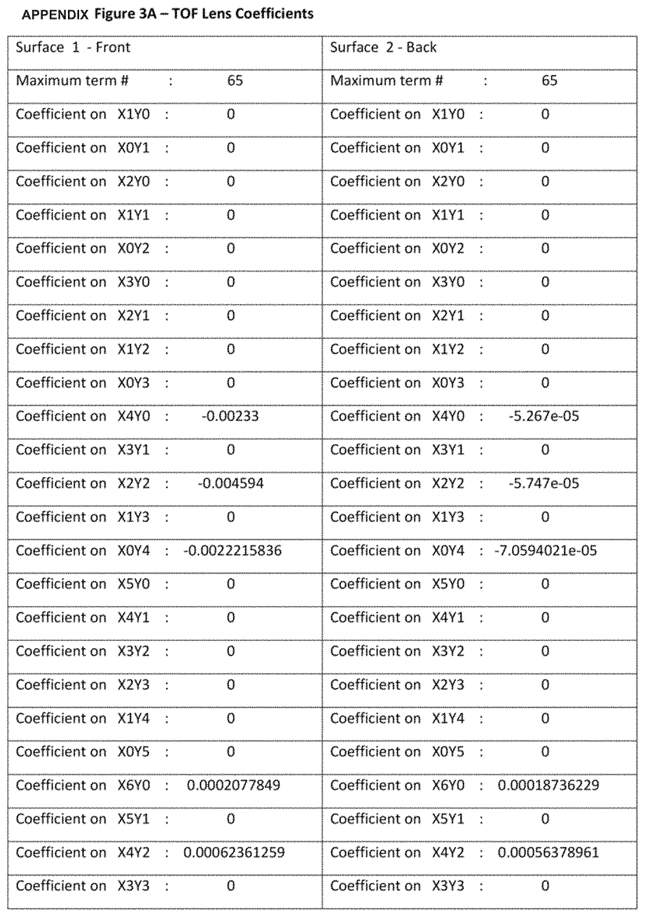

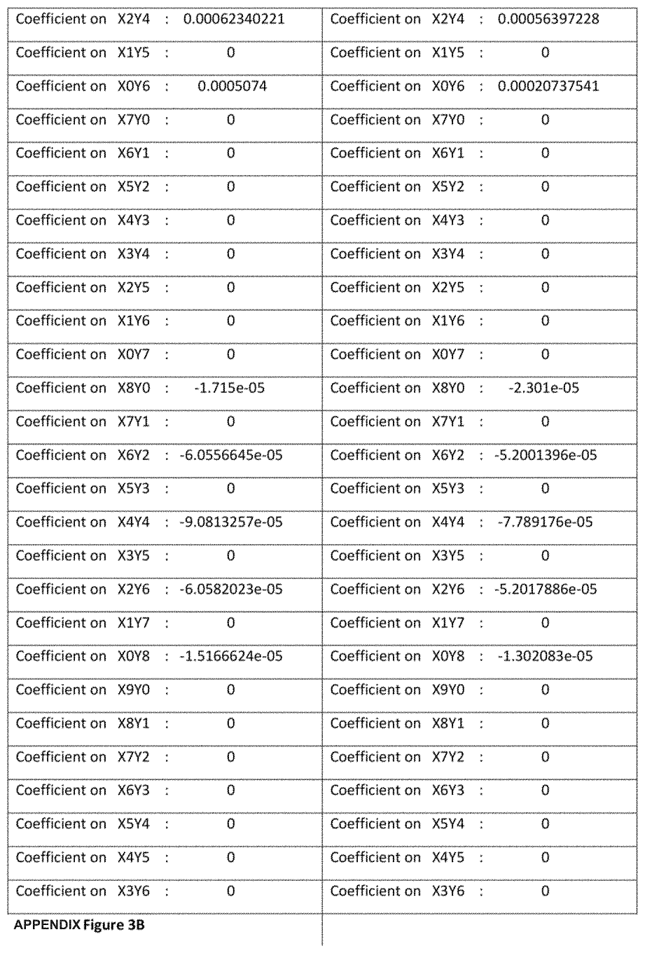

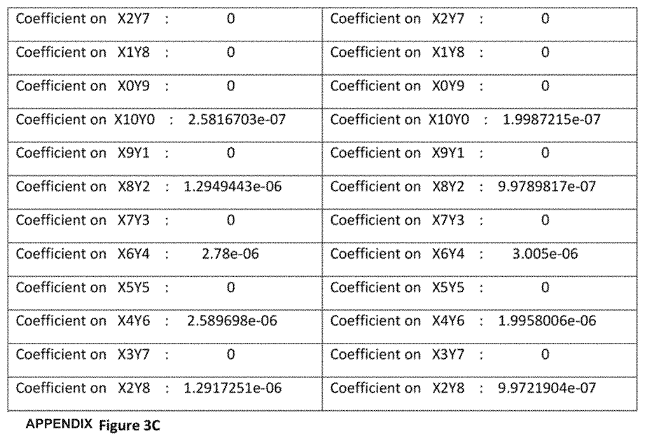

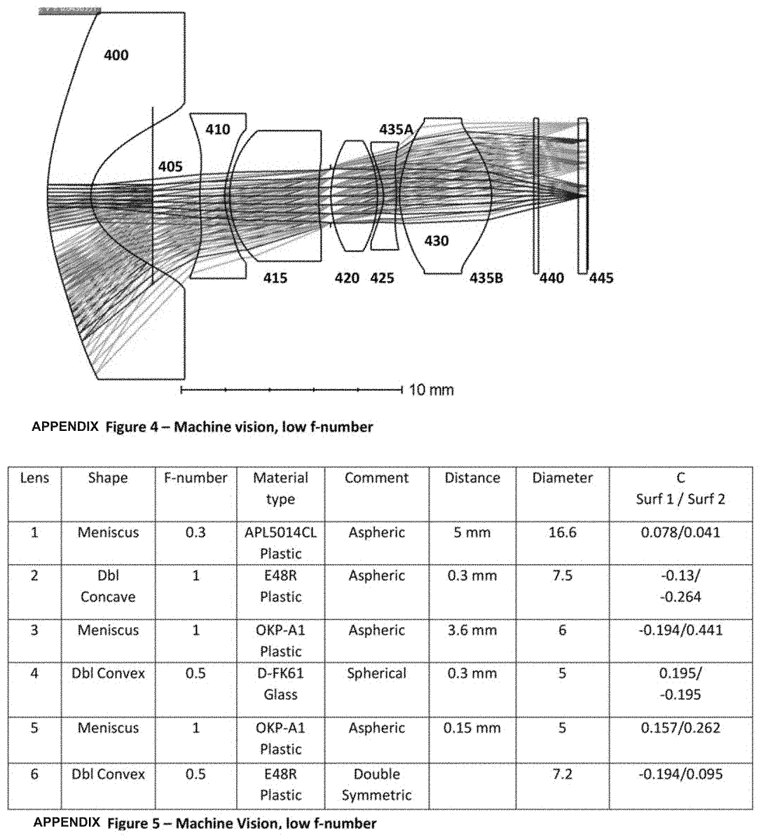

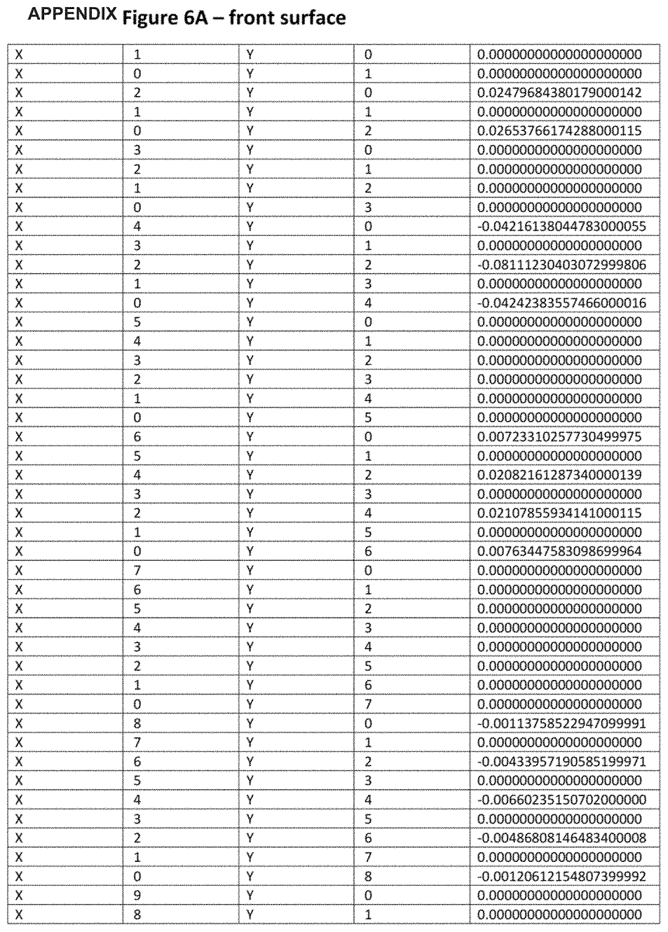

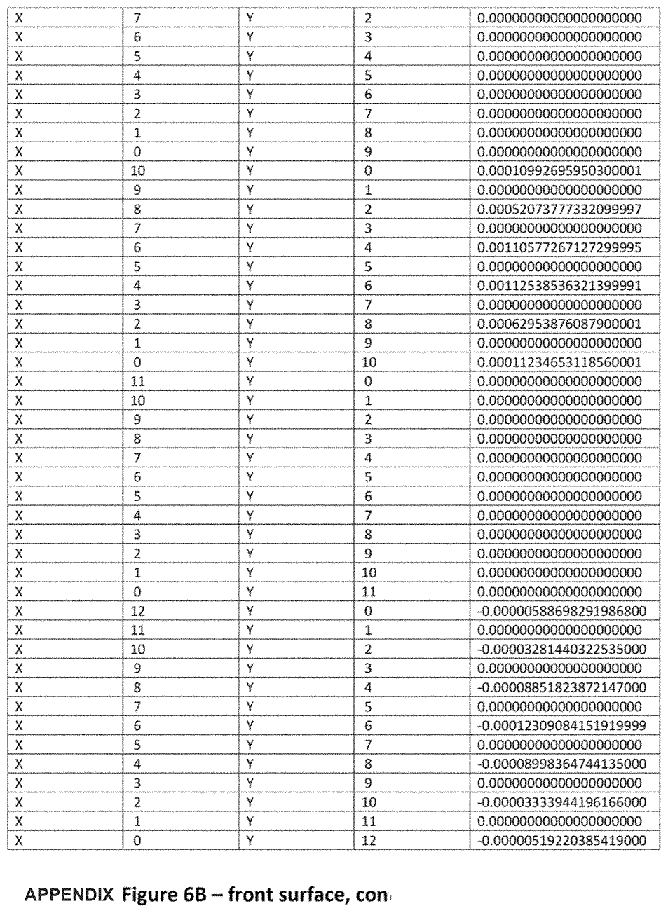

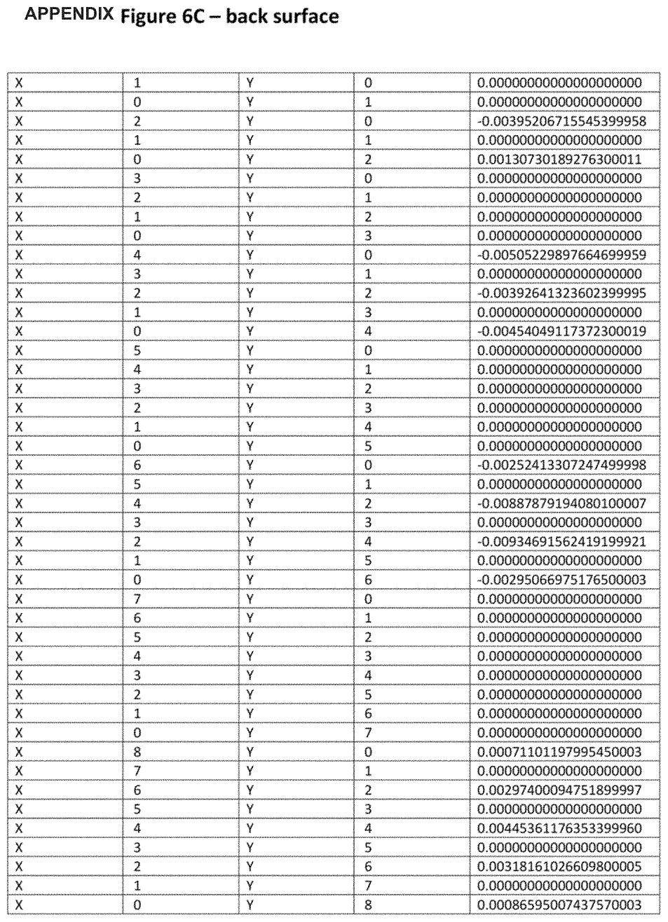

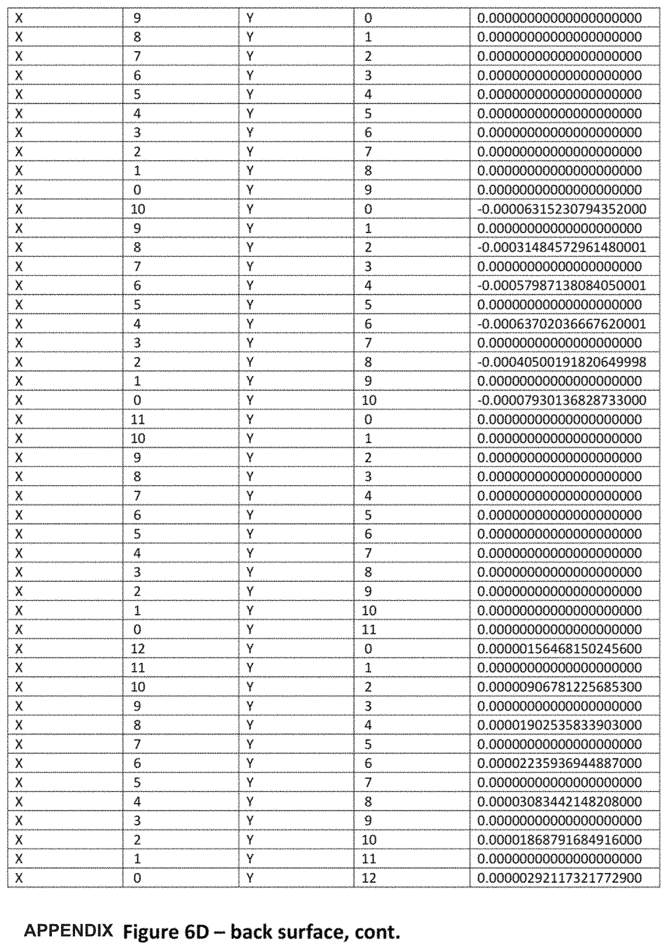

The double plane symmetry front and rear surfaces 3530A-B of element 3525 are defined by the Extended X-Y polynomial shown hereinabove, where the constants have the same meaning. The coefficients Aᵢ thus characterize the double plane symmetry surfaces 3530A-B of element 3525, and can be appreciated from FIGS. 37A-37D. It will be appreciated by those skilled in the art that the values of Ai can vary significantly within the range of −1 to 1.

In general, the following specifications will permit the design of alternative embodiments to the illustrated lens system, but will still define a similar type of lens suitable for use in a visible light mobile phone camera: F-number range is in the range of 1.4 -2.0 (current value is 1.4); the diagonal FOV typically ranges between 45-100 degrees (current value is 75 degrees); optical distortion is preferably low, in the range of 0.5-10% (current value is 2%), but can be allowed to increase as a trade-off against a lower f-number; the ratio of the largest diameter element to optical total track length is in the range of 0.5-1 (Current value ˜0.95); and the ratio of Lens Focal Length to 1^{st} element focal length is in the range of 0.3-2 (Current value ˜0.78).

Those skilled in the art can, given the teachings herein, appreciate that a new and novel design for a wide range of improved lens systems utilizing free form lens elements, including a low distortion lens having at least one element with double plane symmetry usable in a Kepler type telescopic lens, a Galileo type telescopic lens, a wide angle lens, various lenses suitable for mobile use, and lens systems particularly suited for use in machine vision applications, including some for time-of-flight systems. While various embodiments of the invention have been disclosed in detail, it will be appreciated that the features of the exemplary embodiments discussed herein are not to be limiting, and that numerous alternatives and equivalents exist which do not depart from the scope of the invention. As such, the present invention is to be limited only by the appended claims.

### FIELD OF THE INVENTION

This invention relates generally to lens systems using double plane symmetry freeform lenses, and more particularly relates to lens systems using double plane symmetry lens elements for time of flight and machine vision applications where the surface or Z-sag of the double plane symmetry surface is defined by an X-Y polynomial.

### BACKGROUND OF THE INVENTION

The general task of an optical design is to make a perfect conjugation between the object space or plane and the image space or sensor plane, with no aberrations, distortions or other errors. Although many lenses are very good, such perfection is elusive. Even small increments can provide significant benefit.

Rotational symmetry is widely used in conventional lenses, with the field view and the aperture stop both being rotationally symmetric. With only rare exception, this results in the final design comprising rotationally symmetric elements. However, most sensors—the photosensitive structures that record the image—are rectangular in shape. Thus, the image space created by a rotationally symmetric lens creates a circular field of view, while the sensor that records the image is a rectangle.

An inherent characteristic of rotationally symmetric designs is that the optical errors in the lenses are the same at all points equidistant from the center of the lens, even though points outside the area of the sensor are of no consequence to the stored image. Thus, optimal lens performance cannot be matched to the sensor's field of view.

Optics for machine vision applications span a wide range of optical solutions. One subset of machine vision is time of flight (TOF). TOF applications calls for optics that have low f-number, wide field of view, good rejection of stray light, narrow wavelength band, relative uniformity upon illumination, among other considerations, but can tolerate optical distortion. Machine vision applications, viewed more broadly, often are best served by lens systems suitable for creating a planar image, such as those found in smartphone cameras.

Rotationally symmetric lens systems typically cannot meet the requirements for matching object space to the image space defined by a rectangular sensor. This is particularly true when taking into account the above considerations. As a result, there is a need for lens system designs that take into account the particular application when matching the object space to the image space, for example the field of view of a sensor.

### SUMMARY OF THE INVENTION

The present invention provides designs for optical lens systems using at least one double plane symmetry lens element to overcome the limitations of conventional rotationally symmetric designs while also taking into consideration the particular application and the considerations associated with that application. The surface or Z-sag of the double plane symmetry lens elements are defined by X-Y polynomials. More particularly, embodiments of the present invention provide an improved time of flight [TOF] lens system, and an improved visible light machine vision lens system.

Depending upon the embodiment, a freeform optical element as contemplated by the present invention can have one optical surface with double plane symmetry, while the other surface is rotationally symmetrical. Alternatively, both surfaces can have double plane symmetry. Multiple such freeform optical elements are also possible in the optical system. In the case of multiple elements having double plane symmetry, the orientation of the freeform elements in the assembly can be aligned.

Through the use of one or more such double plane symmetry optical elements, the image projected onto the sensor is better matched to the field of view of the sensor, resulting in enhanced resolution of the captured imaged and, effectively, higher resolution.

The elements of these lens systems, and the lenses themselves, can be fabricated using existing techniques and can be scaled in size. These and other benefits of the design of the present invention can be appreciated from the following detailed description of the invention, taken together with the appended figures.

### THE FIGURES

APPENDIX FIG. 1 illustrates an embodiment of the invention suited to infrared time-of-flight systems.

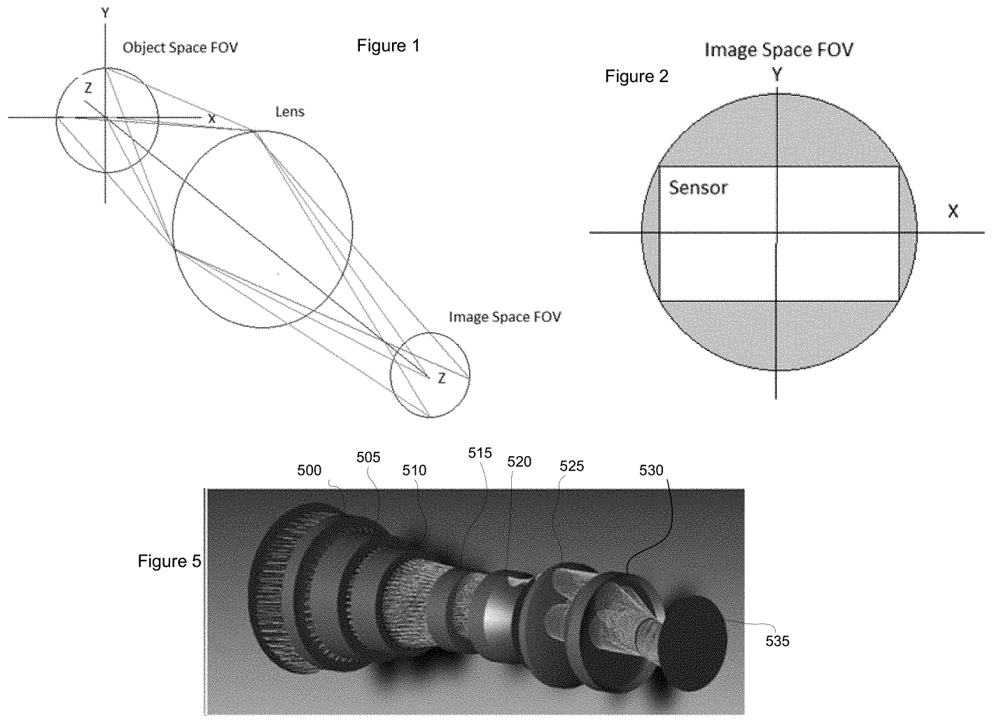

APPENDIX FIG. 2 describes in table form exemplary details of the lens elements shown in FIG. 1.

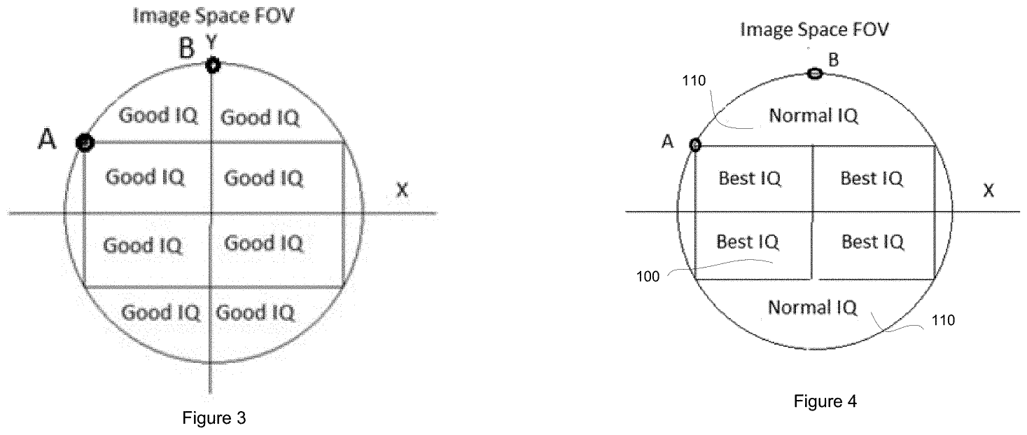

APPENDIX FIGS. 3A-3C describe in table form exemplary coefficients Aᵢ for the infrared TOF lens system shown in FIG. 1.

APPENDIX FIG. 4 illustrates an embodiment of the invention suited for visible light machine vision applications where low f-number is desirable.

APPENDIX FIG. 5 describes in table form exemplary details of the lens elements shown in FIG. 4.

APPENDIX FIGS. 6A-6D describe in table form exemplary coefficients Ai for the front and back surfaces of a double symmetry element used in a visible light machine vision embodiment of FIG. 4 where low f-number is desirable.

Hereinafter, within following Detailed Description of the Invention that forms part of this APPENDIX, the foregoing APPENDIX FIGS. 1-6D will be identified as FIG. 1, FIG. 2, etc., but are distinct from and not to be confused with FIGS. 1-37D of the foregoing Specification. Likewise, the reference numerals used for the elements of the figures in this APPENDIX are for use solely within this APPENDIX and are not to be confused with the reference numerals for the foregoing Specification. Likewise, the paragraph numbers shown in this APPENDIX are for reference solely within this APPENDIX.

### DETAILED DESCRIPTION OF THE INVENTION

Turning first to FIG. 1, an embodiment of the invention directed to time of flight sensing can be better appreciated. It will be appreciated by those skilled in the art that time of flight sensing is a specific type of machine vision. The lens system of FIG. 1 is designed for use in a Time-Of-Flight camera, that is, a range imaging camera system that resolves distance based on the known speed of light, measuring the time-of-flight of a light signal between the camera and the subject for each point of the image. Time of flight can also be considered a non-imaging application even though a sensor is used for detection of the light impinging thereon to make the timing measurement. In the present invention, time of flight sensing utilizes the near infrared band, and more specifically between 850 and 950 nanometers, where a freeform element is double plane symmetric and is defined by an X-Y polynomial.

Unlike most imaging applications, TOF applications typically include a light source. In such TOF applications, and many machine vision applications, providing a light source that enables good relative illumination across the field of view becomes important. While a lens system for the camera in a mobile phone operates acceptably with relative illumination at the edge of only 20% or 30% of the on-axis illumination, TOF applications require better off-axis performance, and relative illumination can be at least 50% of axial illumination.

Stray light is another characteristic where TOF applications impose tighter requirements. While a mobile phone camera operates acceptably with a reduction ratio of 1.0×10−6, stray light for machine vision and TOF applications can be at least 110 −7. Likewise, while the f-number for a mobile phone camera can be 1.8, or 2.0, 2.2, or even higher, the f-number for TOF applications is generally smaller, in the range of 1.0 to 1.6. The f-number for other types of machine vision applications can vary from the low f-number s desired for TOF applications to the higher f-numbers suitable for phone cameras, or even higher. Still further, maintaining good optical performance for off-axis objects (or field points) is desirable for machine vision and TOF applications.

For most time of flight applications, and also for many machine vision applications, low stray light is very important as well as low f-number. In addition, while some machine vision applications do not require a wide field of view (FOV), a wide FOV can be used in many machine vision and TOF applications. For implementations using a wide field of view, very good relative illumination is also desirable. While “normal” cameras such as those in mobile phones are intended to create a planar image, TOF applications have a different objective. In TOF applications, the objective is to obtain spatially correlated data representative of every object in the field of view, or what can be referred to as a depth map. To do so, TOF systems create synchronized signals over every pixel such that the time difference of light illuminating objects in the field of view and being reflected back to the sensor can be accurately determined, thus yielding the desired spatial information about those objects in the field of view.

Referring again to FIG. 1, an embodiment of a TOF lens system is shown. Starting from object space, a first element 100 can be a spherical meniscus lens, followed by a spherical meniscus second element 105 and a spherical double convex third element 110. An optional aperture 115 can be interposed between the second and third elements. A spherical double convex element 120l follows the third element, and, as a fifth element 125, a double plane symmetric meniscus lens element. Cover glass 130 and sensor 135 are at opposite ends of the system. All but the fifth element can be comprised of glass, while the fifth element is typically comprised of plastic. Details of each of the lens elements are shown in FIG. 2. Key parameters of the TOF lens are shown in Table 1, below:

TABLE 1

| Parameter | Value |
|---|---|
| Operating Wavelength | 950 +/− 10 nm (Near Infrared Region) |
| Field Of View | 160 degrees (Diagonal) |
| Optical Total Track | 18.04 mm |
| F-number | 1.3 |
| Effective Focal Length | 2.5 mm |
| Optical Distortion | 77% |
| Relative Illumination | 60% |
| Components | 4 Glass (Spherical) 1 Plastic (Double |
| | Plane Symmetric) |

The Double Plane Symmetry surface is described through an Extended Polynomial equation:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y ) .$$

where z, x, y are cartesian coordinates of the surface, c is surface curvature, r is the surface radial coordinate, k is the conical constant, Aᵢ are polynomial coefficients, Σ(x,y) are polynomials.

Examples of Σ(x,y) are: X²Y², X⁴Y⁶, X⁸Y⁴, etc. Conical constant k in the illustrated embodiment is 0, but can be of any value as long as the term under the square root is greater than or equal to zero.

The above equation gives the freedom to separate x and y coordinates, and to define different coefficients for different XOZ and YOZ planes of the system.

Exemplary values for coefficients Aᵢ for the lens system of FIG. 1 are shown in FIGS. 3A-3C.

Values for coefficients Aᵢ for other embodiments can vary significantly from design to design. In general, the following specifications will permit the design of alternative embodiments to the illustrated lens system, but will still define a similar type of lens suitable for infrared time of flight applications: F-number in the range of 1.0-2.0 (current value is 1.3); diagonal FOV in the range of 130-180 degrees (current value is 160 degrees); optical distortion is less important in this application, can be corrected generally; ratio of largest diameter element to optical Total Track Length is in the range of 0.25-0.8 (Current value ˜0.58); ratio of Lens Focal Length to third element focal length is in the range of 0.3-1 (Current value ˜0.4). As for the freeform coefficients: second order coefficients (e.g. X2Y0) define paraxial (close to optical axis) properties of the optical lens—focal length and etc., while all the other higher orders are used for different aberration correction. Those skilled in the art will recognize that the freeform coefficients Aᵢ presented in the table of FIGS. 3A-3C can take dramatically different values within a range of −1 to 1, but still define a very similar lens.

Turning next to FIG. 4, a still further embodiment of the invention can be better appreciated. The embodiment of FIG. 4 is designed for use in visible light machine vision applications. The machine vision lens illustrated in FIG. 4 can, in one embodiment and starting from object space, comprise a first aspheric meniscus element 400, followed by an optional aperture 405, n turn followed by an aspheric double concave element 410, then an aspheric meniscus lens element 415, a spherical double convex glass element 420, a second aspheric meniscus element 425, and finally a double convex element 430 having double plane symmetry front and rear surfaces 435A-B. Cover glass 440 and sensor 445 are shown for ease of reference. Each of the elements except 420 can be comprised of a suitable plastic as discussed for the foregoing embodiments. Details of each of the foregoing elements are shown in FIG. 5. Key parameters of the embodiment shown in FIG. 4 are set forth in Table 2, below.

TABLE 2

| Parameter | Value |
|---|---|
| Operating Waveband | 470 . . . 650 nm (Visible Region) |
| Field Of View | 120 degrees (Diagonal) |
| Optical Total Track | 24.5 mm |
| F-number | 1.8 |
| Effective Focal Length | 2.11 mm |
| Optical Distortion | 5% |
| Relative Illumination | 50% |
| Components | 4 Plastic (Aspherical) 1 Glass |
| | (Spherical) 1 Plastic (Double Sym) |

As with the embodiments shown in FIG. 1, the double plane symmetry front and rear surfaces 435A-B are defined by the same Extended X-Y Polynomial shown and discussed hereinabove, although with different coefficients as shown in FIG. 5. For the illustrated embodiment, exemplary coefficients A are shown in FIG. 6A-6D-, where FIGS. 6A-6B show the front surface coefficients and FIGS. 6C-6D shown the back surface coefficients. For such an embodiment, other front surface charactistics can be radius of 3.27448025, conic of 0.00000000, and semi-diameter of 2.94296383, while other rear surface characteristics can be radius of −11.84566104, conic of 0.00000000, and semi-diameter of 3.26747467.

In general, the following specifications will permit the design of alternative embodiments to the illustrated lens system, but will still define a similar type of lens suitable for use in a visible light machine vision camera: f-number range is in the range of 1.5-1.9 (current value is 1.8); the diagonal FOV typically ranges between 75-120 degrees (current value is 120 degrees); optical distortion is preferably low, in the range of 0.5-10% (Current value is 5%), but can be allowed to increase as a trade-off against a lower f-number; the ratio of the largest diameter element to optical Total Track Length is in the range of 0.5-1 (Current value ˜0.66); and the ratio of Lens Focal Length to 4^{th} element focal length is in the range of 0.3-2 (Current value ˜0.38).

Those skilled in the art can, given the teachings herein, appreciate that multiple embodiments of the invention have been disclosed herein, specifically an infrared time of flight lens system, and a low f-number lens system for use in visible light machine vision applications. Each embodiment takes advantage of the benefits of a lens element with at least one surface having double plane symmetry as defined by an X-Y Polynomial. It will be appreciated that numerous alternatives and equivalents exist which do not depart from the scope of the invention. As such, the present invention is to be limited only by the appended claims.

### ABSTRACT

Lens systems for use in infrared time of flight applications, and visible light machine vision application, each with at least one surface of a lens element having double plane symmetry as defined by an X-Y Polynomial. The lens elements of the invention can be implemented using existing manufacturing techniques.

We claim:

1. A lens system having a plurality of lens elements for forming an image on a sensor, the system configured to be internal to a cellular phone and having a total track length less than the Z height of the cellular phone, comprising
at least one aspheric lens, and
at least one double plane symmetry lens having the Z sag of at least one surface thereof defined by the equation
$$z = \frac{{cvr}^{2}}{1 + \sqrt{1 - {cv}^{2} ( cc + 1 ) {r}^{2}}} + {\sum }_{i = 0}^{n} ( asi ) {Z}_{i}$$
wherein coefficient CV is curvature, CC is a conic constant, r is a radial coordinate, Zᵢ are polynomials that comply with the equations
Zₙ^{m}(r, θ)=Rₙ^{m}(r, θ)sin(mθ)
and
Zₙ^{-m}(r, θ)=Rₙ^{m}(r)cos(mθ)
where the radial polynomial R follows the equation
$${R}_{n}^{m} ( r ) = {\sum }_{k = 0}^{\frac{n - m}{2}} \frac{{( - 1 )}^{k} ( n - k ) !}{k ! ( \frac{n + m}{2} - k ) ! ( \frac{n - m}{2} - k )} * {r}^{n - 2 k}$$
the coefficients as, are corresponding Zernike coefficients, in the radial polynomial R n=0,1,2, . . . is the degree and m=−n ton is the order, and
wherein the lens elements are comprised of materials suitable for resolving images in a waveband of 470-650 nm.

2. A lens system having a plurality of lens elements for forming an image on a sensor, the system configured to be internal to a cellular phone and having a total track length less than the Z height of the cellular phone, comprising
at least one aspheric lens, and
at least one double plane symmetry lens having at least one surface thereof defined by the equation
$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y ) .$$
where z, x, and y are Cartesian coordinates of the surface, c is surface curvature, r is a surface radial coordinate, k is a conical constant, Aᵢ are polynomial coefficients, and Σ(x,y) are polynomials.
